(19) United States
(12) Patent Application Publication
(10) Pub. No.: US 2020/0300465 A1
(43) Pub. Date: Sep. 24, 2020

(54) ROTARY FURNACE

(71) Applicant: HUNAN DINGJIU ENERGY AND ENVIRONMENT TECHNOLOGY LTD., Hunan (CN)

(72) Inventor: Liangzheng JIANG, Changsha (CN)

(21) Appl. No.: 15/779,561

(22) PCT Filed: Nov. 23, 2016
(86) PCT No.: PCT/CN2016/106867

§ 371 Date: May 29, 2018

(30) Foreign Application Priority Data
Nov. 27, 2015 (CN) 201510848576.8

(51) Int. Cl. F23G 5/20; F27B 7/32

(52) U.S. Cl. CPC F23G 5/20; F27B 7/33; F27B 7/3205

(57) ABSTRACT

A rotary furnace comprises a roller (2), a feeding end of the roller (2) being higher than a discharge end of the roller (2), and also comprises: a feeding device (1), communicated with the feeding end of the roller (2) in a way of rotary seal; a discharge device (6), communicated with the discharge end of the roller (2) in a way of rotary seal; a driving device, arranged outside the roller (2) and used for driving the roller (2) to make reciprocating oscillation around the rotating axis thereof; a support device, arranged outside the roller (2) and used for rotating and supporting the roller (2); a control device, connected to the driving device by a lead and used for controlling the radian of the reciprocating oscillation of the roller (2). A roller (2) only oscillates at a certain radian and does not rotate along the single direction, such that a device or a pipeline used for fabrication processing can be arranged on the outer wall of the roller (2); and furthermore, the oscillation of the roller (2) is not limited, which is beneficial to the treatment such as heating, cooling and reacting for materials.

The present application claims the priority to Chinese Patent Application No. 201510848576.8 titled “ROTARY FURNACE”, filed with the Chinese State Intellectual Property Office on Nov. 27, 2015, the entire disclosure thereof is incorporated herein by reference.

### FIELD

The present application relates to the technical field of chemical equipment, and particularly relates to a rotary furnace.

### BACKGROUND

Energy exists in various forms in the natural world. At present, an utilization rate of some unconventional solid materials, such as garbage, sludge, biomass, inorganic compounds, low-rank coal, oil shale, oil sludge and the like, is not high. By processes such as heating, cooling, reaction and the like, the unconventional solid materials can be transformed into energy and materials for human use. With the continuous intensification of energy shortages, using unconventional materials for energy and material conversion has attracted wide attention of industry participants.

A conversion process of the above materials usually includes processes such as pyrolysis, gasification, carbonization, activation, reaction, cooling and the like, which are generally carried out by a rotary furnace. A conventional rotary furnace is generally composed of a roller, a furnace head and a furnace tail, the furnace head and the furnace tail are fixed, and rotatably and sealingly connected to two ends of the roller respectively, to perform dynamic and static sealing with the two ends of the roller, and the roller is driven by an external drive device to rotate continuously. The roller of the conventional rotary furnace rotates continuously, and sealing faces of the two ends of the roller with the furnace head and the furnace tail are large, therefore, the sealing of the roller with the furnace head and the furnace tail is difficult, and the air leakage rate is high; especially for the rotary furnace in a high temperature working condition, due to the thermal extension/contraction of a furnace body and the limitation of a dynamic sealing material in high temperature conditions, the sealing performance is very poor, which greatly affect the manufacturing technology. Besides, due to the continuous rotation of the roller, other devices used for technical reactions cannot be mounted on an peripheral wall of the roller, since other devices are required to be connected to external equipment through wires or pipes, they can only be mounted at the furnace head and the furnace tail, therefore, processes inside the roller cannot be effectively completed, an outer wall of the roller cannot be connected to external pipes, a fluid material cannot directly enter and exit from the outer wall of the roller, but can only enter and exit from the furnace head and the furnace tail, which is not conducive to the control of the material at a middle portion of the rotary furnace. The above factors are not beneficial to the processing of the material.

Therefore, a technical issue to be addressed by those skilled in the art is to solve the problem that the rotary furnace has poor sealing performance, and devices used for technical reactions cannot be mounted on the peripheral wall of the roller, resulting in that the material treatment process cannot be effectively completed.

### SUMMARY

In view of this, an object of the present application is to provide a rotary furnace, to improve the sealing performance thereof, enable a fluid medium to enter and exit through a peripheral wall of the rotary furnace, and allow a device used for technical reactions to be mounted on the peripheral wall of the rotary furnace, thus facilitates the control of the material inside a roller, and is beneficial to the treatment of waste, sludge, biomass, inorganic compounds, low-rank coal, oil shale, oil sludge and the like.

In order to achieve the above object, a technical solution is provided as follows according to the present application:

a rotary furnace includes a roller, a feed end and a discharge end of the roller each is a closed end face, and the feed end is higher than the discharge end, and the rotary furnace further includes:

a feed device rotatably and sealingly communicating with a feed inlet at the feed end of the roller, wherein a cross-sectional area of the feed inlet is smaller than the cross-sectional area of the feed end, and an axis of the feed inlet coincides with a rotational axis of the rotary furnace;

a discharge device communicatedly arranged at the discharge end of the roller, wherein a roller material outlet is at a position rotatably and sealingly cooperating with the discharge device, a cross-sectional area of the roller material outlet is smaller than a cross-sectional area of the discharge end, and an axis of the roller material outlet coincides with the rotational axis of the rotary furnace;

a drive device arranged outside the roller, and configured to drive the roller to oscillate reciprocatingly around the rotational axis of the rotary furnace;

a support device arranged outside the roller, and configured to rotatably support the roller to oscillate reciprocatingly around the rotational axis of the rotary furnace; and

an oscillation control device connected to the drive device through wires, and configured to control the drive device to motion, to control a radian and frequency of the reciprocating oscillation of the roller.

Preferably, the rotary furnace further includes a movable duct assembly communicatedly arranged on the roller and configured to allow a fluid material or a heat source to enter and exit the roller.

Preferably, the rotary furnace is a concentric oscillating rotary furnace or an eccentric oscillating rotary furnace; a rotational axis of the concentric oscillating rotary furnace coincides with the axis of the roller; the eccentric oscillating rotary furnace is an in-roller eccentric oscillating rotary furnace or an out-roller eccentric oscillating rotary furnace, a rotational axis of the in-roller eccentric oscillating rotary furnace lies inside the roller and does not coincide with the axis of the roller, and a rotational axis of the out-roller eccentric oscillating rotary furnace lies outside the roller; the axis of the roller oscillates reciprocatingly around a rotational axis of the eccentric oscillating rotary furnace.

Preferably, according to the rotary furnace, the eccentric oscillating rotary furnace is further provided with a weight balancing block.

Preferably, according to the rotary furnace, a drive device of the concentric oscillating rotary furnace is a concentric wheel gear and ring gear drive device, and a support device of the concentric oscillating rotary furnace is a concentric riding wheel and riding ring support device;

the concentric wheel gear and ring gear drive device includes:

a ring gear fixed on a peripheral wall of the roller, wherein an axis of the ring gear coincides with the axis of the roller;

a drive gear meshing with the ring gear; and

a powered component transmissionly connected to the drive gear;

the concentric riding wheel and riding ring support device includes:

a riding ring fixed on the peripheral wall of the roller, wherein an axis of the riding ring coincides with the axis of the roller; and

a riding wheel in contact with and supporting an outer ring surface of the riding ring, wherein an axis of the riding wheel is fixed, and the riding wheel is configured to rotatably support the riding ring.

Preferably, according to the rotary furnace, the drive device of the concentric oscillating rotary furnace is a concentric pushrod drive device, and the support device of the concentric oscillating rotary furnace is a concentric riding wheel and riding ring support device;

the concentric riding wheel and riding ring support device includes:

a riding ring fixed on the peripheral wall of the roller, wherein the axis of the riding ring coincides with the axis of the roller; and

a riding wheel in contact with and supporting the outer ring surface of the riding ring, wherein the axis of the riding wheel is fixed, and the riding wheel is configured to rotatably support the riding ring;

the concentric pushrod drive device includes at least a telescopic cylinder, a telescopic rod of the telescopic cylinder is hinged to the roller, a fixed end of the telescopic cylinder is hinged to a fixed table, and the roller is driven by the extension and contraction of the telescopic cylinder to oscillate reciprocatingly.

Preferably, according to the rotary furnace, the drive device of the concentric oscillating rotary furnace is at least a set of concentric riding wheel and riding ring drive device, and the support devices of the concentric oscillating rotary furnace are a plurality of sets of concentric riding wheel and riding ring support devices;

each set of the concentric riding wheel and riding ring drive device includes:

a riding ring fixed on the peripheral wall of the roller, wherein the axis of the riding ring coincides with the axis of the roller;

a riding wheel in contact with and supporting the outer ring surface of the riding ring, wherein the axis of the riding wheel is fixed, and the riding wheel is configured to rotatably support the riding ring; and

a powered component transmissionly connected to the riding wheel;

each set of the concentric riding wheel and riding ring support devices includes:

a riding ring fixed on the peripheral wall of the roller, wherein the axis of the riding ring coincides with the axis of the roller; and

a riding wheel in contact with and supporting the outer ring surface of the riding ring, wherein the axis of the riding wheel is fixed, and the riding wheel is configured to rotatably support the riding ring.

Preferably, according to the rotary furnace, a drive device of the out-roller eccentric oscillating rotary furnace is an eccentric wheel gear and ring gear drive device, and a support device of the eccentric oscillating rotary furnace is a support roller support device;

the eccentric wheel gear and ring gear drive device includes:

a ring gear fixed on the peripheral wall of the roller, wherein the axis of the ring gear coincides with the rotational axis of the eccentric oscillating rotary furnace;

a drive gear meshing with the ring gear; and

a powered component transmissionly connected to the drive gear;

the support roller support device includes:

a support frame fixed in position; and

a support roller rotatably connected to the support frame wherein an axis of the support roller coincides with the rotational axis of the eccentric oscillating rotary furnace, and two ends of the support roller are fixedly connected to a bottom portion of the roller and the weight balancing block respectively.

Preferably, according to the rotary furnace, a drive device of the eccentric oscillating rotary furnace is an eccentric wheel gear and ring gear drive device, and a support device of the eccentric oscillating rotary furnace is an eccentric riding wheel and riding ring support device;

the eccentric wheel gear and ring gear drive device includes:

a ring gear fixed on the peripheral wall of the roller, wherein the axis of the ring gear coincides with the rotational axis of the eccentric oscillating rotary furnace;

a drive gear meshing with the ring gear; and

a powered component transmissionly connected to the drive gear;

the eccentric riding wheel and riding ring support device includes:

a riding ring fixed on the peripheral wall of the roller, wherein the axis of the riding ring coincides with the rotational axis of the eccentric oscillating rotary furnace, and the weight balancing block is fixed on the riding ring; and

a riding wheel in contact with and supporting the outer ring surface of the riding ring, wherein the axis of the riding wheel is fixed, and the riding wheel is configured to rotatably support the riding ring.

Preferably, according to the rotary furnace, the drive device of the eccentric oscillating rotary furnace is an eccentric pushrod drive device, and the support device of the eccentric oscillating rotary furnace is an eccentric riding wheel and riding ring support device;

the eccentric riding wheel and riding ring support device includes:

a riding ring fixed on the peripheral wall of the roller, wherein the axis of the riding ring coincides with the axis of the roller, and the weight balancing block is fixed on the riding ring; and

a riding wheel in contact with and supporting the outer ring surface of the riding ring, wherein the axis of the riding wheel is fixed, and the riding wheel is configured to rotatably support the riding ring;

the eccentric pushrod drive device includes at least one telescopic cylinder, the telescopic rod of the telescopic cylinder is hinged to the riding ring, the fixed end of the telescopic cylinder is hinged to the fixed table, and the riding ring is driven by the extension and contraction of the telescopic cylinder to oscillate reciprocatingly.

Preferably, according to the rotary furnace, the drive device of the out-roller eccentric oscillating rotary furnace is an eccentric pushrod drive device, and the support device of the eccentric oscillating rotary furnace is a support roller support device;

the support roller support device includes:

a support frame fixed in position; and

a support roller rotatably connected to the support frame, wherein the axis of the support roller coincides with the rotational axis of the eccentric oscillating rotary furnace, and two ends of the support roller are fixedly connected to the bottom portion of the roller and the weight balancing block respectively;

the eccentric pushrod drive device includes:

a hinge frame fixed on the support roller; and

at least one telescopic cylinder, the telescopic rod of the telescopic cylinder is hinged to the hinge frame, the fixed end of the telescopic cylinder is hinged to the fixed table, and the support roller is driven by the extension and contraction of the telescopic cylinder to oscillate reciprocatingly.

Preferably, according to the rotary furnace, the drive device of the eccentric oscillating rotary furnace is an eccentric riding wheel and riding ring drive device, and the support devices of the concentric oscillating rotary furnace are a plurality of sets of eccentric riding wheel and riding ring support devices;

the eccentric riding wheel and riding ring drive device includes:

a riding ring fixed on the peripheral wall of the roller, wherein the axis of the riding ring coincides with the rotational axis of the eccentric oscillating rotary furnace, and the weight balancing block is fixed on the riding ring;

a riding wheel in contact with and supporting the outer ring surface of the riding ring, wherein the axis of the riding wheel is fixed, and the riding wheel is configured to rotatably support the riding ring; and

a powered component transmissionly connected to the riding wheel;

each set of the eccentric riding wheel and riding ring support devices includes:

a riding ring fixed on the peripheral wall of the roller, wherein the axis of the riding ring coincides with the rotational axis of the eccentric oscillating rotary furnace, and the weight balancing block is fixed on the riding ring; and

a riding wheel in contact with and supporting the outer ring surface of the riding ring, wherein the axis of the riding wheel is fixed, and the riding wheel is configured to rotatably support the riding ring.

Preferably, according to the rotary furnace, the movable duct assembly is a hose; or the movable duct assembly is formed by connecting at least two sub-pipes head-to-tail through a rotary joint; or the movable duct assembly is a fixed oscillating pipe, the fixed oscillating pipe is fixedly connected to an outer wall of the roller, one end of the fixed oscillating pipe is rotatably connected to an external pipe through the rotary joint, and a rotational axis of the rotary joint coincides with the rotational axis of the eccentric oscillating rotary furnace.

Preferably, according to the rotary furnace, wherein the feed device is a spiral feed conveyor or a piston feeder, a conveying pipe of each of the spiral feed convey and the piston feeder is rotatably and sealingly connected to the feed inlet at the feed end of the roller, and a conveying axis of each of the spiral feed convey and the piston feeder coincides with the rotational axis of the rotary furnace.

Preferably, according to the rotary furnace, the discharge device is a spiral discharge conveyor, a conveying pipe of the spiral discharge conveyor is rotatably and sealingly connected to the roller material outlet at the discharge end of the roller, and a conveying axis of the spiral discharge conveyor coincides with the rotational axis of the rotary furnace.

Preferably, according to the rotary furnace, the discharge device of the eccentric oscillating rotary furnace is a piston discharger or a discharge pipe; a conveying pipe of the piston discharger is in communication with the discharge end of the roller, an outlet of the conveying pipe of the piston discharger is rotatably and sealingly connected to an external fixed discharge pipe, and a conveying axis of the piston discharger coincides with the rotational axis of the out-roller eccentric oscillating rotary furnace;

the discharge pipe is rotatably and sealingly connected to the roller material outlet arranged on the end face of the discharge end of the roller, a roller wall, in a solid phase region near the discharge end, of the roller is connected to the roller material outlet through a slope, and an axis of the discharge pipe coincides with the rotational axis of the out-roller eccentric oscillating rotary furnace; or

the roller wall of the solid phase region at the discharge end of the roller is provided with an unloading pipe, the roller material outlet is an outlet of the unloading pipe, the discharge pipe is rotatably and sealingly connected to the roller material outlet, and the axis of the discharge pipe coincides with the rotational axis of the out-roller eccentric oscillating rotary furnace.

Preferably, according to the rotary furnace, the oscillation control device includes a position sensor and an electric control cabinet both connected through wires, the position sensor is fixed on the support device or the roller, and the drive device is connected to the electric control cabinet through wires.

Preferably, the rotary furnace further includes a heat exchange jacket and/or an electric heating device arranged on the roller, the heat exchange jacket is connected to an external device through the movable duct assembly, or the heat exchange jacket is in communication with an interior of the roller through a fixed pipe fixed on a roller wall of the roller; the electric heating device is connected to a second control device through wires, to control a power supply volume of the electric heating device.

Preferably, in the rotary furnace, the electric heating device is one of or a various combination of a heating wire heating device, a microwave heating device, an electromagnetic heating device, and a plasma heating device.

Preferably, in the rotary furnace, the microwave heating device is fixed at an outer side of the roller wall of the roller through a high temperature resistant and wave-transparent layer or a metal waveguide tube, and the high temperature resistant and wave-transparent layer is in contact with the interior of the roller, and the metal waveguide tube is in communication with the interior of the roller.

Preferably, in the rotary furnace, the high temperature resistant and wave-transparent layer configured to partition the metal waveguide tube is further arranged inside the metal waveguide tube.

Preferably, the rotary furnace further includes a plurality of temperature sensors and/or pressure sensors arranged at the roller and/or the heat exchange jacket, the temperature sensors and/or the pressure sensors are connected to the second control device through wires, to monitor temperature and/or pressure parameters at a position of each of radial sections in the interior of the roller in an axial direction thereof and/or inside the heat exchange jacket.

Preferably, in the rotary furnace, valves are arranged in the movable duct assembly and/or the fixed pipe.

Preferably, in the rotary furnace, the valves are manual valves and/or automatic valves, the automatic valves are connected to the second control device through wires, for the control of opening degrees of the automatic valves.

Preferably, the rotary furnace further includes a number of partitions fixed in the roller, the partitions are perpendicular to the axis of the roller, each of the partitions is provided with an opening, and the openings are located in a solid material moving region in the roller.

Preferably, the rotary furnace further includes a number of movable chains arranged in the roller, wherein an end portion of each of the movable chains is fixed on an inner wall of the roller and/or the partition, and the plurality of movable chains pass through the openings of the partitions.

Preferably, the rotary furnace further includes a number of turnover plates fixed on the inner wall of the roller and located in the solid material moving region of the roller, the turnover plates are configured to turn over a solid material to make the solid material to come into full contact with a gaseous phase; and the turnover plate near the discharge device can turn over and guide the solid material into the discharge device.

Compared with the conventional technology, beneficial effects of the present application are as follows.

According to the rotary furnace according to the present application, the roller is driven by the drive device and supported by the support device, the roller oscillates reciprocatingly around the axis of the rotary furnace, the radian and frequency of the reciprocating oscillation of the roller are controlled by the control device, and a motion of the drive device is controlled by the control device, to achieve an object of controlling the radian of the reciprocating oscillation. The feed device rotatably and sealingly communicates with the feed inlet at the feed end of the roller, the cross-sectional area of the feed inlet is smaller than the cross-sectional area of the feed end, and the axis of the feed inlet coincides with the rotational axis of the rotary furnace; the discharge device is communicatedly arranged at the discharge end of the roller, the roller material outlet is at the position rotatably and sealingly cooperating with the discharge device, the cross-sectional area of the roller material outlet is smaller than the cross-sectional area of the discharge end, and the axis of the roller material outlet coincides with the rotational axis of the rotary furnace. Since end faces of the two ends of the roller are closed, compared with the conventional technology, in which the fixed furnace head and furnace tail are rotatably connected around outer peripheries at two open ends of the roller, according to the present application, sealing faces of the rotatable sealing of the two ends of the roller with the feed device and the discharge device are greatly reduced, therefore, an ordinary sealing member can be used for sealing, the sealing is simple, and the sealing performance is improved. A material enters the roller from the feed end of the roller through the feed device, due to the reciprocating oscillation of the roller and the feed end being higher than the discharge end, the material moves to the discharge end along a reciprocating zigzag path, and exits from the discharge end of the roller through the discharge device. Since the rotary furnace according to the present application oscillates reciprocatingly only within a certain radian range and does not rotate continuously in a single direction, devices used for material technological treatment, such as the sensors and/or the electric heating device both required to be connected to the external device through wires or the heat exchange jacket required to be connected to the external device through the pipe and the like, can be directly mounted on the roller, and the normal oscillation of the roller will not be obstructed, which is more beneficial to the treatment of materials such as waste, sludge, biomass, inorganic compounds, low-rank coal, oil shale, oil sludge and the like.

According to an embodiment of the present application, the movable duct assembly is connected to the roller, the movable duct assembly itself can bend, turn or rotate, and the roller oscillates only within a certain radian range and does not rotate in a single direction, therefore, the movable duct assembly will not be wound around the roller to limit the oscillation of the roller. The fluid medium can directly enter and exit from the peripheral wall of the roller through the movable duct assembly, and unlike the conventional technology, in which the fluid medium needs to enter the roller through the furnace head and the furnace tail. Because there is no need to go through the sealing faces around the roller, leakage of the fluid material is reduced, and the sealing performance of the rotary furnace is further improved. Besides, that the fluid medium directly enters and exits from the peripheral wall of the roller is more beneficial to the technical treatment of the material in the roller.

According to another embodiment of the present application, the outer wall of the roller is provided with the heat exchange jacket and/or the electric heating device, the medium for heat transfer with the material in the roller is introduced into the heat exchange jacket, and the electric heating device is connected to the control device. Therefore, according to the corresponding technological requirements, the heat exchange jacket and/or the electric heating device are arranged to realize the temperature control in the roller, which is more beneficial to the material treatment.

According to another embodiment of the present application, the roller is further provided with the temperature sensors and/or pressure sensors, since the roller oscillates only within a certain radian range, the temperature sensors and/or pressure sensors can be connected to a detection control device through wires, to monitor temperature and/or pressure parameters at the position of each of radial sections in the interior of the roller in the axial direction thereof, to improve the accuracy of the temperature and pressure control in the roller, which is more beneficial to the material treatment.

### BRIEF DESCRIPTION OF THE DRAWINGS

For more clearly illustrating embodiments of the present application or the technical solutions in the conventional technology, drawings referred to describe the embodiments or the conventional technology will be briefly described hereinafter. Apparently, the drawings in the following description are only some examples of the present application, and for those skilled in the art, other drawings may be obtained based on these drawings without any creative efforts.

FIG. 1 is a schematic view showing the structure of a concentric oscillating rotary furnace according to an embodiment of the present application;

FIG. 2 is a schematic view showing the structure of a drive device and a support device of the concentric oscillating rotary furnace according to the embodiment of the present application;

FIG. 3 is a schematic view showing the structure of another type of drive device and support device of the concentric oscillating rotary furnace according to the embodiment of the present application;

FIG. 4 is a schematic view showing the structure of an eccentric oscillating rotary furnace (an out-roller eccentric oscillating rotary furnace) according to the embodiment of the present application;

FIG. 5 is a schematic view showing the structure of a drive device and a support device of the eccentric oscillating rotary furnace according to the embodiment of the present application;

FIG. 6 is a schematic view showing the structure of another type of drive device and support device of the eccentric oscillating rotary furnace according to the embodiment of the present application;

FIG. 7 is a schematic view showing the structure of a third type of drive device and support device of the eccentric oscillating rotary furnace according to the embodiment of the present application;

FIG. 8 is a schematic view showing the structure of a fourth type of drive device and support device of the eccentric oscillating rotary furnace according to the embodiment of the present application (only suitable for the out-roller eccentric oscillating rotary furnace);

FIG. 9 is a schematic view showing the structure of a feed device of the eccentric oscillating rotary furnace according to the embodiment of the present application;

FIG. 10 is a schematic view showing the structure of a discharge device of the eccentric oscillating rotary furnace according to the embodiment of the present application;

FIG. 11 is a schematic view showing the structure of another type of discharge device of the eccentric oscillating rotary furnace (the out-roller eccentric oscillating rotary furnace) according to the embodiment of the present application;

FIG. 12 is a schematic view showing the structure of a third type of discharge device of the eccentric oscillating rotary furnace (the out-roller eccentric oscillating rotary furnace) according to the embodiment of the present application;

FIG. 13 is a schematic view showing the structure of a fourth type of discharge device of the eccentric oscillating rotary furnace (the out-roller eccentric oscillating rotary furnace) according to the embodiment of the present application;

FIG. 14 is a schematic view showing the structure of a partition of a rotary furnace according to an embodiment of the present application;

FIG. 15 is a schematic view showing the mounting of a movable chain of the rotary furnace according to the embodiment of the present application;

FIG. 16 is a side view of FIG. 13;

FIG. 17 is a schematic view showing the mounting of another movable chain of the rotary furnace according to the embodiment of the present application;

FIG. 18 is a schematic view showing an oscillating process of the concentric oscillating rotary furnace according to the embodiment of the present application;

FIG. 19 is a schematic view showing an oscillating process of an eccentric oscillating rotary furnace (an in-roller eccentric oscillating rotary furnace) according to the embodiment of the present application;

FIG. 20 is a schematic view showing a working principle of a movable duct assembly of the eccentric oscillating rotary furnace (the in-roller eccentric oscillating rotary furnace) according to the embodiment of the present application;

FIG. 21 is a schematic view showing a working principle of another type of movable duct assembly of the eccentric oscillating rotary furnace (the in-roller eccentric oscillating rotary furnace) according to the embodiment of the present application;

FIG. 22 is a schematic view showing the connection of a fixed oscillating pipe of the eccentric oscillating rotary furnace (the in-roller eccentric oscillating rotary furnace) according to the embodiment of the present application;

FIG. 23 is a schematic view showing a cross section of a turnover plate of the rotary furnace according to the embodiment of the present application;

FIG. 24 is a schematic view showing the mounting structure of a microwave heating device of the rotary furnace according to the embodiment of the present application;

FIG. 25 is a schematic view showing another mounting structure of a microwave heating device of the rotary furnace according to the embodiment of the present application;

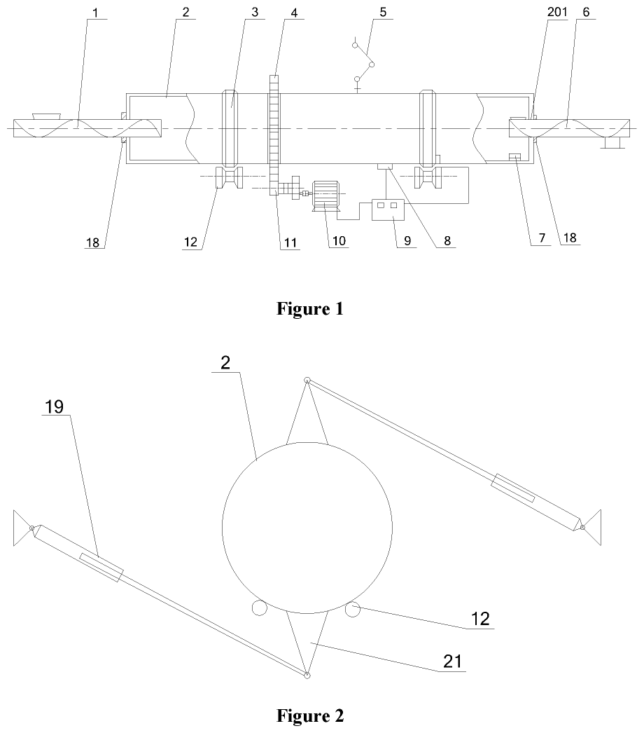

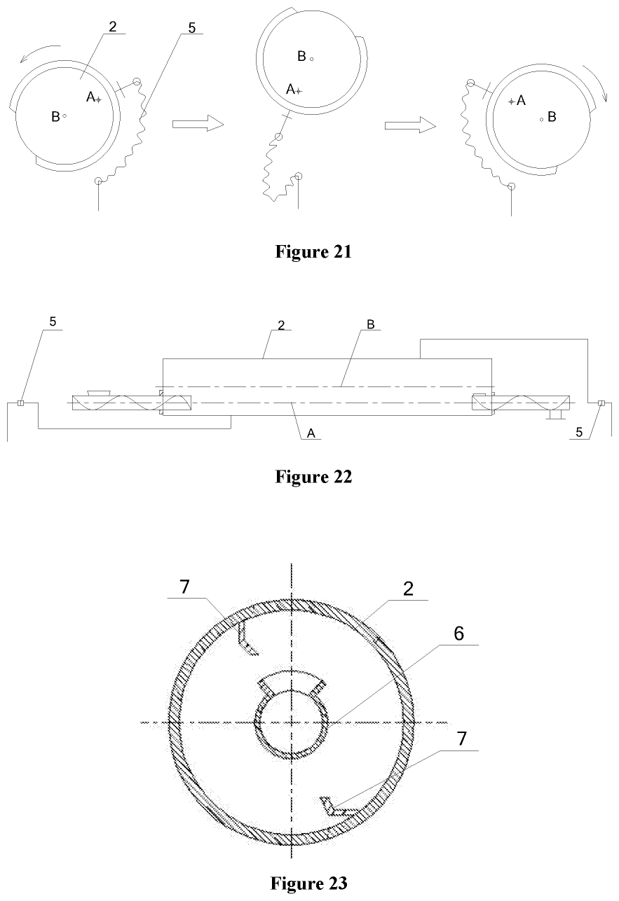

Reference numerals in FIGS. 1 to 25:

| | |
|---|---|
| 1 | feed device, |
| 101 | first gate valve, |
| 102 | second gate valve, |
| 2 | roller, |
| 201 | roller material outlet, |
| 3 | riding ring, |
| 501 | sub-pipe, |
| 502 | rotary joint, |
| 6 | discharge device, |
| 601 | external fixed discharge pipe, |
| 602 | unloading pipe, |
| 7 | turnover plate, |
| 8 | temperature sensor, |
| 9 | electric control cabinet, |
| 10 | powered component, |
| 11 | drive gear, |
| 12 | riding wheel, |
| 13 | movable chain, |
| 14 | partition, |
| 15 | weight balancing block, |
| 16 | support roller, |
| 17 | support frame, |
| 18 | straight-through rotary joint, |
| 19 | telescopic cylinder, |
| 20 | electric heating device, |
| 202 | high temperature resistant and wave-transparent material, |
| 203 | metal waveguide tube, |
| 21 | hinge frame, |
| A | rotational axis of rotary furnace, |
| B | axis of roller. |

### DETAIL DESCRIPTION

An aspect of the present application is to provide a rotary furnace, to improve the sealing performance thereof, enable a fluid medium to enter and exit through a peripheral wall of the rotary furnace, and allow a device used for technical reactions to be mounted on the peripheral wall of the rotary furnace, thus facilitates the control of a material inside a roller, and is beneficial to the treatment of waste, sludge, biomass, inorganic compounds, low-rank coal, oil shale, oil sludge and the like.

The technical solution according to the embodiments of the present application will be described clearly and completely as follows in conjunction with the accompany drawings in the embodiments of the present application. It is obvious that the described embodiments are only a part of the embodiments according to the present application, rather than all of the embodiments. All the other embodiments obtained by those skilled in the art based on the embodiments in the present application without any creative work belong to the scope of the present application.

Referring to FIGS. 1 and 4, a rotary furnace is provided according to the present application, including a roller 2, a feed device 1, a discharge device 6, a drive device, a support device and an oscillation control device.

Two ends of the roller 2 respectively are the feed end and the discharge end, end faces of both the feed end and the discharge end are closed, and the feed end is higher than the discharge end. Preferably, an included angle between an axis B of the roller 2 and the horizontal plane ranges from 1° to 15°. A material can slide slowly, by a self-weight, from the feed end to the discharge end in the roller 2, which facilitates the discharge, and a sliding speed is moderate, to complete each of technical processes.

The feed end of the roller 2 is provided with a feed inlet, an axis of the feed inlet coincides with a rotational axis A of the rotary furnace, and the feed device 1 rotatably and sealingly communicates with the feed inlet. A sealing method may be a dynamic and static sealing method such as a packing seal, a mechanical seal and the like. A cross-sectional area of the feed inlet is smaller than a cross-sectional area of the feed end, and a cross section is a plane perpendicular to the axis of the roller 2. The feed device 1 is fixed, the roller 2 can rotate with respect to the feed device 1, the feed device 1 and the roller 2 are sealed by the dynamic and static sealing method, and a conveying axis of the feed device 1 (that is, the axis of rotation of the roller 2 with respect to the feed device 1, and also the axis of the feed inlet) coincides with the rotational axis A of the rotary furnace.

The discharge device 6 is communicatedly arranged at the discharge end of the roller 2, a roller material outlet 201 is at a position rotatably and sealingly cooperating with the discharge device 6, and the material is discharged from the roller 2 or the discharge device 6 through the roller material outlet 201. A cross-sectional area of the roller material outlet 201 is smaller than a cross-sectional area of the discharge end, an axis of the roller material outlet 201 coincides with the rotational axis A of the rotary furnace, and a conveying axis of the discharge device 6 (that is, the axis of the roller material outlet 201 coincides with the rotational axis A of the rotary furnace.

The drive device is arranged outside the roller 2, to drive the roller 2 to oscillate reciprocatingly around the rotational axis A of the rotary furnace.

The support device is arranged outside the roller 2, to rotatably support the roller 2 to oscillate reciprocatingly around the rotational axis A of the rotary furnace.

The oscillation control device is arranged outside the roller 2, and is connected to the drive device through wires, to control the drive device to motion, so as to control a radian and frequency of the reciprocating oscillation of the roller 2. In this embodiment, the radian of the reciprocating oscillation of the roller 2 preferably ranges from 60° to 360°, and more preferably ranges from 180° to 270°.

When the rotary furnace is in operation, as shown in FIG. 1, the material is conveyed to the roller 2 through the feed device 1, after the material enters the roller 2, the roller controls the drive device to motion through the oscillation control device, and the oscillation control device drives the roller 2 to oscillate reciprocatingly; the roller 2 is rotatably supported by the support device, under an effect of an oblique angle of the roller 2 and the reciprocating oscillation of the roller 2, the material moves in a zigzag path toward the discharge end, and the corresponding technological treatment is completed in the roller 2, finally the material is discharged from the discharge device.

Compared with the rotary furnace in the conventional technology, the rotary furnace according to the present application employs a reciprocating oscillation structure, the roller 2 oscillates reciprocatingly only within a certain radian range and does not rotate continuously in a single direction, therefore, devices used for technological treatment, such as the sensor and/or the electric heating device both required to be connected to an external device through wires or a heat exchange jacket required to be connected to the external device through a pipe and the like, can be directly mounted on the roller 2, and the wires and the pipe will not be wound around the roller 2, thus the normal oscillation of the roller will not be obstructed, which is more beneficial to the treatment of materials such as waste, sludge, biomass, inorganic compounds, low-rank coal, oil shale, oil sludge and the like. Compared with the conventional technology, in which a fixed furnace head and a fixed furnace tail are rotatably connected around outer peripheries at two open ends of the roller, in the present application, end faces of the two ends of the roller are closed, and sealing faces of the rotatable sealing of the two ends of the roller 2 with the feed device 1 and the discharge device 6 are greatly reduced, therefore, an ordinary sealing member can be used for sealing, the sealing is simple, and the sealing performance is improved.

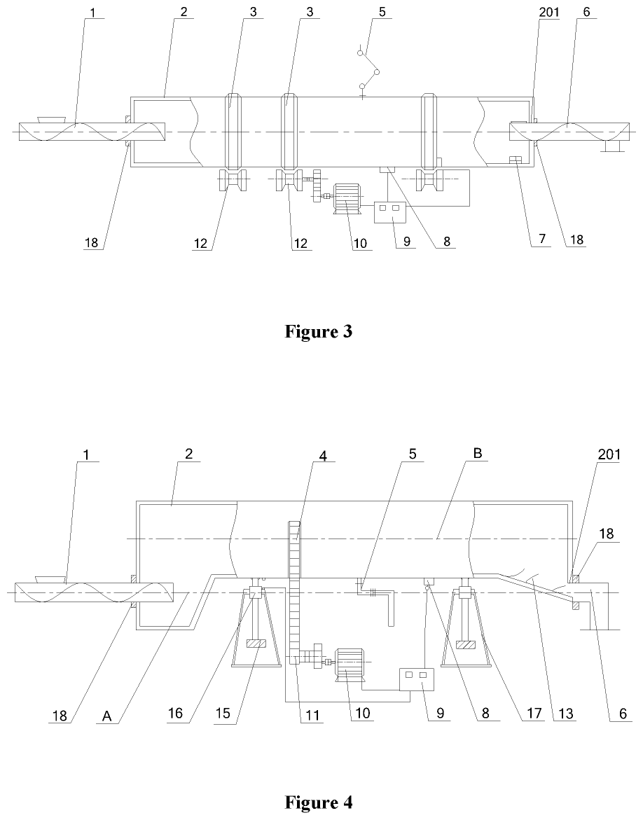

As shown in FIG. 1, FIGS. 3 to 6 and FIGS. 18 to 22, the rotary furnace in this embodiment further includes a movable duct assembly 5 arranged on the roller 2 and configured to allow a fluid material or a heat source to enter and exit the roller, and the movable duct assembly 5 can bend, turn or rotate. The number of the movable duct assembly 5 is determined according to actual technical requirements, which is not specifically limited herein. The roller 2 oscillates only within a certain radian range and does not rotate in a single direction, therefore, the movable duct assembly 5 which can bend, turn or rotate can be directly mounted on the roller 2, the movable duct assembly 5 will not be wound around the roller due to the oscillation of the roller 2 to limit the oscillation of the roller 2. A fluid medium can directly enter and exit the roller 2 through the movable duct assembly 5, which is more beneficial to the treatment of the material. Besides, by directly mounting the movable duct assembly 5 on the roller 2, the fluid material and the heat source can directly enter and exit the roller 2, not like the conventional technology, in which the fluid material and the heat source needs to enter the roller through the furnace head and the furnace tail, therefore, there is no need to go through the sealing faces around the roller 2, leakage of the fluid material is reduced, and the sealing performance of the rotary furnace is further improved.

The rotary furnace according to the present application has two structural forms, as shown in FIG. 1, FIGS. 3 to 6 and FIG. 22, the rotary furnace in FIGS. 1 and 3 is a concentric oscillating rotary furnace, that is, the rotational axis A of the rotary furnace coincides with the axis B of the roller 2, the rotary furnace in FIGS. 4 to 6 and FIG. 22 is an eccentric oscillating rotary furnace, that is, the rotational axis A of the rotary furnace does not coincide with the axis B of the roller 2, and the axis B of the roller 2 oscillates reciprocatingly around the rotational axis A of the rotary furnace. There are two types of eccentric oscillating rotary furnaces according to a position of the rotational axis A, one type is an in-roller eccentric oscillating rotary furnace shown in FIG. 22, wherein a rotational axis A of the in-roller eccentric oscillating rotary furnace is inside the roller 2; another type is an out-roller eccentric oscillating rotary furnace shown in FIGS. 4 to 6, wherein a rotational axis A of the out-roller eccentric oscillating rotary furnace is outside the roller 2. In this embodiment, preferably, the rotational axis A is located below an exterior of the roller 2, to facilitate the arrangement of the support device, the drive device and the movable duct assembly 5. Besides, an end face of the feed end of the roller 2 of the out-roller eccentric oscillating rotary furnace may extend to the rotational axis A of the out-roller eccentric oscillating rotary furnace, or may not extend to the rotational axis A of the out-roller eccentric oscillating rotary furnace, which is specifically determined according to the structure of the feed device 1; an end face of the discharge end may also extend to the rotational axis A of the out-roller eccentric oscillating rotary furnace, or may not extend to the rotational axis A, which is specifically determined according to the structure of the discharge device 6. The concentric oscillating rotary furnace, the in-roller eccentric oscillating rotary furnace and the out-roller eccentric oscillating rotary furnace are generally similar in structure, except that a shape of the roller 2, the drive device, the support device, and the discharge device 6 are different.

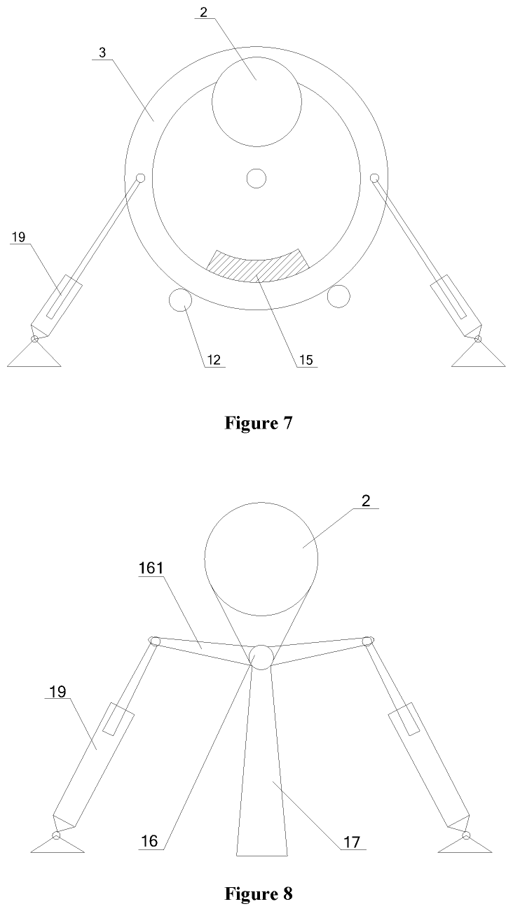

As shown in FIGS. 4 and 7, the eccentric oscillating rotary furnace is further provided with a weight balancing block 15, and a centroid axis of the weight balancing block 15 and a centroid axis of the roller 2 are arranged symmetrically with respect to the rotational axis A of the rotary furnace, to provide gravity and an inertia force to balance the roller 2 when the roller 2 is oscillating, so that the oscillation of the roller 2 is more effortless and smooth.

As shown in FIG. 1, the concentric oscillating rotary furnace is taken as an example to illustrate the embodiment. The roller 2 of the concentric oscillating rotary furnace preferably is of a cylindrical shape with two ends closed, the feed device 1 and the discharge device 6 are rotatably and sealingly connected to the end faces of the two ends of the roller 2 respectively. A drive device and a support device of the concentric oscillating rotary furnace is provided according to the embodiment, the drive device is a concentric wheel gear and ring gear drive device, and the support device is a concentric riding wheel and riding ring support device. Wherein the concentric riding wheel and riding ring support device includes at least two sets of riding rings 3 and riding wheels 12, each of the riding rings 3 is fixed on a peripheral wall of the roller 2, and an axis of each of the riding rings 3 coincides with the axis B of the roller 2; an outer ring surface of the riding ring 3 is in contact with and supports the riding wheel 12, the riding wheel 12 is located below the riding ring 3, and a rotational axis of the riding wheel 12 is fixed in position; each of the riding rings 3 corresponds to at least one riding wheel 12, preferably two riding wheels 12, to support the rotation of the roller 2, and the two sets of riding rings 3 and riding wheels 12 are preferably arranged near the two ends of the roller 2 for more stable supporting. The concentric wheel gear and ring gear drive device includes at least a set of a ring gear 4, a drive gear 11 and a powered component 10, the ring gear 4 is fixed on the peripheral wall of the roller 2, and an axis of the ring gear 4 coincides with the axis B of the roller 2, the ring gear 4 meshes with drive gear 11, and the drive gear 11 is transmissionly connected to the powered component 10. The powered component 10 may be an electric motor or a hydraulic motor, in a case that the powered component 10 is the electric motor, the drive gear 11 can be transmissionly connected to the electric motor by a speed reducer; and in a case that the powered component 10 is the hydraulic motor, the drive gear 11 can be directly connected to the hydraulic motor or transmissionly connected to the hydraulic motor by the speed reducer. The powered component 10 is connected to the oscillation control device through wires, the oscillation control device controls a rotating direction of the powered component 10, and drives the drive gear 11 to oscillate reciprocatingly through the powered component 10, thus drives the ring gear 4 and the roller 2 to oscillate reciprocatingly around the rotational axis A. Preferably, the ring gear 4 may be composed of the riding ring 3 and a tooth-shaped ring, that is, the tooth-shaped ring is fixed on any side face, perpendicular to an axis of the riding ring 3, of the riding ring 3, and the tooth-shaped ring rotates together with the riding ring 3 to form the ring gear 4, in this way, the ring gear 4 can be manufactured by using the riding ring 3, which reduces the manufacturing difficulty and the manufacturing cost. At the same time, the riding ring 3 fixed with the tooth-shaped ring can continue to cooperate with the riding wheel 12 for supporting; or, the tooth-shaped ring can be fixed on the outer ring of the riding ring to form the ring gear 4. This structural form of the ring gear 4 is particularly suitable for the eccentric oscillating rotary furnace, and can be also employed by the concentric oscillating rotary furnace. Of course, the ring gear 4 may also be separately manufactured to be an integral structure.

As shown in FIG. 2, another type of drive device and support device of the concentric oscillating rotary furnace are provided according to the embodiment, wherein the drive device is a concentric pushrod drive device, and the support device is a concentric riding wheel and riding ring support device. The concentric riding wheel and riding ring support device includes at least a set of a riding ring 3 and a riding wheel 12, the riding ring 3 is fixed on the peripheral wall of the roller 2, and the axis of the riding ring 3 coincides with the axis B of the roller 2; an outer ring surface of the riding wheel 12 is in contact with and supports the riding ring 3, the riding wheel 12 is located below the riding ring 3, and the riding wheel 12 is fixed in position to rotatably support the riding ring 3; one riding ring 3 preferably meshes with two riding wheels 12, more preferably, the concentric riding wheel and riding ring support device includes two sets of riding rings 3 and riding wheels 12, the two sets of riding rings 3 and riding wheels 12 are located at the two ends of the roller 2 respectively, thus the supporting is more stable. The concentric pushrod drive device includes at least a telescopic cylinder 19, a telescopic rod of the telescopic cylinder 19 is hinged to the roller 2, a fixed end of the telescopic cylinder 19 is hinged to a fixed table, and the roller 2 is driven by the extension and contraction of the telescopic cylinder to oscillate reciprocatingly. Specifically, a hinge frame 21 is arranged on the outer wall of the roller 2, the hinge frame 21 extends outward in a radial direction of the roller 2, and the telescopic rod of the telescopic cylinder 19 is hinged at an outer end of the hinge frame 21, thus can prevent the telescopic rod from colliding with the roller 2 during extension and contraction processes. In this embodiment, two telescopic cylinders 19 are preferably employed, correspondingly, there are two hinge frames 21, and the two hinge frames 21 are symmetrically arranged up and down with respect to the axis B of the roller 2, and the telescopic rods of the two telescopic cylinders 19 are connected to the two hinge frames 21, namely an upper hinge frame and a lower hinge frame respectively, the telescopic rods of the two telescopic cylinders 19 are hinged to the fixed tables at two sides of the roller 2; a connecting line between the two fixed tables is horizontally arranged, the two fixed tables are symmetrically arranged with respect to a rotational axis A of the concentric oscillating rotary furnace, and the reciprocating oscillation of the roller 2 is achieved through the alternate extension/contraction of the two telescopic cylinders 19. Of course, the number of the telescopic cylinder 19 may also be one, three or more, a position of the telescopic cylinder 19 is arranged according to actual requirements, and is not limited to the forms listed in this embodiment, as long as the reciprocating oscillation of the roller 2 can be realized.

As shown in FIG. 3, a third type of drive device and support device of the concentric oscillating rotary furnace are provided according to the embodiment, wherein the drive device is at least a set of concentric riding wheel and riding ring drive device, and the support device is a plurality of sets of concentric riding wheel and riding ring support devices. Each set of the concentric riding wheel and riding ring support device includes at least a riding ring 3 and a riding wheel 12, the riding ring 3 is fixed on the peripheral wall of the roller 2, and the axis of the riding ring 3 coincides with the axis B of the roller 2; the outer ring surface of the riding wheel 12 is in contact with and supports the riding ring 3, the riding wheel 12 is located below the riding ring 3, and the riding wheel 12 is fixed in position to rotatably support the riding ring 3; one riding ring 3 preferably meshes with two riding wheels 12, more preferably, the support device includes two sets of riding rings 3 and riding wheels 12, and the two sets of riding rings 3 and riding wheels 12 are located at the two ends of the roller 2 respectively, thus the supporting is more stable. The concentric riding wheel and riding ring drive device includes a riding ring 3, a riding wheel 12 and a powered component 10, the riding ring 3 is fixed on the peripheral wall of the roller 2, and the axis of the riding ring 3 coincides with the axis B of the roller 2; the outer ring surface of the riding wheel 12 is in contact with and supports the riding ring 3, the riding wheel 12 is located below the riding ring 3, and the riding wheel 12 is fixed in position to rotatably support the riding ring 3; one riding ring 3 preferably cooperates with two riding wheels 12 for supporting, the powered component 10 is transmissionly connected to the riding wheel 12, the powered component 10 drives the riding wheel 12 to rotate reciprocatingly, and the riding ring 3 is driven by static fraction between the riding wheel 12 and the riding ring 3 to oscillate reciprocatingly, and then the roller 2 oscillates reciprocatingly.

A specific oscillation control device of the concentric oscillating rotary furnace is provided according to the embodiment, including a position sensor and an electric control cabinet 9. The position sensor is fixed on the roller 2 or the support device, to monitor the radian of the reciprocating oscillation of the roller 2, and send position information of the oscillation of the roller 2 to the electric control cabinet 9; the electric control cabinet 9 is connected to the position sensor and the drive device both through wires, the electric control cabinet 9 is used to receive the position information from the position sensor, in a case that the position information is an extreme position of the oscillation of the roller 2, that is, a maximum oscillation radian of the roller 2 in a single direction is achieved, the electric control cabinet 9 controls the motor 10 to change a rotation direction, or the electric control cabinet controls an extension/contraction direction of the telescopic cylinder 19, to control the reciprocating oscillation of the roller 2. A radian of the reciprocating oscillation of the concentric oscillating rotary furnace ranges from 90° to 360°, and an optimal angle ranges from 180° to 270°.

Or, another oscillation control device is employed, the oscillation control device controls motions of the drive device only through a program, the program sets a revolution number and a speed of rotation, in a single direction, of the drive gear 11 or the riding wheel 12, or the program sets travel and a speed of the telescopic cylinder 19, the revolution number or the travel are both in a certain relationship with the oscillation radian of the roller 2; and when the roller 2 oscillates in a single direction to a preset position (corresponding to the revolution number, in this direction, of the drive gear 11 or the riding wheel 12, or corresponding to the travel of the telescopic cylinder 19, the oscillation control device automatically controls the motor 10 to change the rotation direction, or controls the telescopic cylinder 19 to change the extension/contraction direction, to realize the reciprocating oscillation of the roller 2 and reach a limited oscillation radian. Of course, the oscillation control device may employ other structural forms, as long as the roller 2 can oscillate reciprocatingly within a certain radian range without drifting of a reference point of the oscillation of the roller 2.

As shown in FIG. 1, FIGS. 3 to 6 and FIGS. 17 to 22, the movable duct assembly 5 is optimized in the embodiment, the movable duct assembly 5 has three types, all suitable for the concentric oscillating rotary furnace and the eccentric oscillating rotary furnace. The drawings only show the mounting structure of three types of movable duct assemblies 5 in a rotary furnace of a certain structural form, and the three types of movable duct assemblies 5 can be randomly combined with the concentric oscillating rotary furnace and the oscillating rotary furnace. As shown in FIG. 18, a first type of movable duct assembly 5 is a hose, the hose is in communication with the roller 2 through a short adapter pipe on the outer wall of the roller 2, and another end of the hose is connected to the external device; the hose can be bent, and it is ensured that the hose is long enough, so that the hose will not interfere with the oscillation of the roller 2; since the roller 2 oscillates within a certain radian range, the hose will not be wound around the roller 2. The short adapter pipe connected to the hose can be arranged at any position on the outer wall of the roller 2, as long as the hose will not be wounded.

As shown in FIG. 1, FIG. 3 and FIGS. 18 to 20, a second type of movable duct assembly 5 is formed by connecting at least two sub-pipes 501 head-to-tail through a rotary joint 502. A temperature of the rotary furnace is relatively high during operation, and the temperatures of some media introduced into the movable duct assembly 5 are relatively high, therefore, the movable duct assembly 5 preferably employs a pipe made of a hard high temperature resistant material; in order not to interfere with the oscillation of the roller 2, the at least two hard sub-pipes 501 are rotatably connected head-to-tail through the rotary joint 502, with the oscillation of the roller 2, the sub-pipes 501 rotate relative to each other without limiting the oscillation of the roller 2; one sub-pipe communicates with the short adapter pipe on the roller 2 through the rotary joint 502, and another sub-pipe 501 is connected to an external pipe through the rotary joint 502. The movable duct assembly 5 in FIG. 18 is formed by rotatably connecting three sub-pipes 501 head-to-tail through the rotary joint 502; the roller 2 oscillates from a starting position in a certain direction, during the oscillation, the movable duct assembly 5 is driven to rotate, in a whole process, the movable duct assembly 5 does not interfere with the oscillation of the roller 2; the short adapter pipe may be arranged at an upper portion or a lower portion of the outer wall of the roller of the concentric oscillating rotary furnace, the short adapter pipe is connected with the sub-pipes 501 through the rotary joint 502, which is similar to the arrangement in FIGS. 18 and 20, as long as the movable duct assembly 5 does not interfere with the oscillation of the roller 2.

As shown in FIGS. 4 to 6 and FIG. 22, a third type of movable duct assembly 5 is a fixed oscillating pipe 503, the arrangement of the fixed oscillating pipe 503 of the concentric oscillating rotary furnace is similar to the arrangement in FIG. 22, that is, one end of the fixed oscillating pipe 503 is fixedly connected to the outer wall of the roller 2, or may be fixed on the heat exchange jacket in a case that there is a heat exchange jacket; another end of the fixed oscillating pipe 503 extends to two ends of an exterior of the concentric oscillating rotary furnace, and is rotatably connected to the external pipe through the rotary joint 502, the rotary joint 502 is arranged at the two ends of the exterior of the concentric oscillating rotary furnace, and a rotational axis of the rotary joint 502 coincides with an extension line of the axis B of the roller 2 of the concentric oscillating rotary furnace. When the concentric oscillating rotary furnace oscillates reciprocatingly, the fixed oscillating pipe 503 oscillates around the axis B of the roller 2 together with the roller 2, the fixed oscillating pipe 503 will not interfere with the oscillation of the roller 2, and the fluid material or the heat source can be fed into the roller 2 or the heat exchange jacket through the fixed oscillating pipe 503. The end of the fixed oscillating pipe 503 can be fixed on the upper portion or the lower portion of the outer wall of the roller 2.

As for the fixed oscillating pipe 503 of the eccentric oscillating rotary furnace, in a case that the eccentric oscillating rotary furnace is an in-roller eccentric oscillating rotary furnace, the arrangement of the fixed oscillating pipe 503 is similar to the arrangement of the fixed oscillating pipe 503 of the concentric oscillating rotary furnace. As shown in FIG. 22, one end of the fixed oscillating pipe 503 is fixedly connected to the outer wall of the roller 2 or the heat exchange jacket, another end of the fixed oscillating pipe 503 extends out of two ends of an exterior of the in-roller eccentric oscillating rotary furnace, and is rotatably connected to the external pipe through the rotary joint 502, the rotary joint 502 is arranged at the two ends of the exterior of the in-roller eccentric oscillating rotary furnace, and the rotational axis of the rotary joint 502 coincides with an extension line of the rotational axis A of the in-roller eccentric oscillating rotary furnace, and a working principle thereof is similar to the working principle of the concentric oscillating rotary furnace. In a case that the eccentric oscillating rotary furnace is an out-roller eccentric oscillating rotary furnace, the rotational axis A thereof is located below the exterior of the roller 2, and the arrangement of the fixed oscillating pipe 503 is shown in FIGS. 4 to 6; one end of the fixed oscillating pipe 503 is fixedly connected to a lower portion of the roller 2 or the heat exchange jacket, another end of the fixed oscillating pipe 503 is rotatably connected to the external pipe through the rotary joint 502, the rotary joint 502 is located below the roller 2, and the rotational axis of the rotary joint 502 coincides with the rotational axis A of the out-roller eccentric oscillating rotary furnace. The working principle is described hereinbefore, and will not be further described.

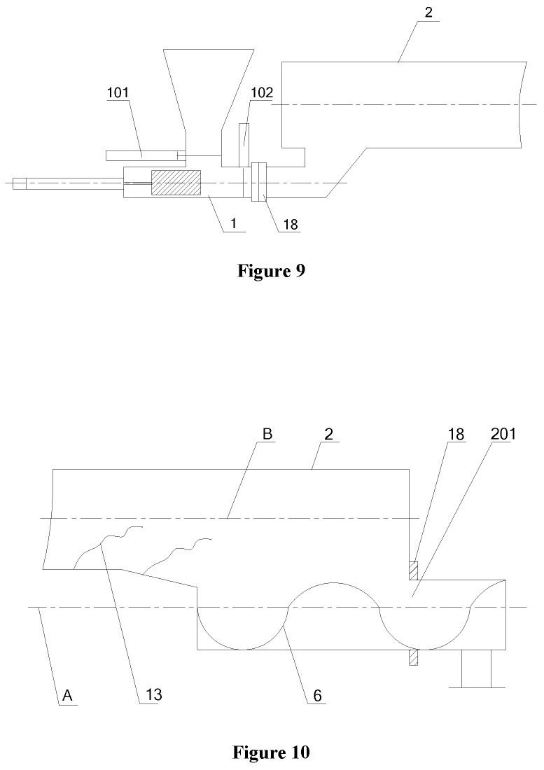

As shown in FIGS. 1, 3 and 9, the feed device 1 of the concentric oscillating rotary furnace is optimized in the embodiment, wherein the feed device 1 is a spiral feed conveyor or a piston feeder. As shown in FIGS. 1 and 3, the spiral feed conveyor is a circular pipe structure, a spiral mechanism is arranged in the circular pipe, one end of the feed device 1 is provided with a feed bin having an upward opening, the circular pipe is rotatably and sealingly connected to the feed inlet opened on the end face of the feed end of the roller 2, the circular pipe can be rotatably connected to the end face of the feed end through a straight-through rotary joint 18 (the straight-through rotary joint is a type of connecting member for the dynamic and static sealing), and a conveying axis of the spiral feed conveyor coincides with the rotational axis of the roller 2. The spiral feed conveyor conveys the material into the roller 2 through the spiral mechanism. In a case that the piston feeder is employed, the structure thereof is the same as the structure in FIG. 9, similarly, a conveying pipe of the piston feeder is rotatably and sealingly connected to the feed inlet opened on the end face of the feed end of the roller 2 through the straight-through rotary joint 18, and a conveying axis of the conveying pipe of the piston feeder coincides with the rotational axis of the roller 2, the piston feeder pushes the material into the roller 2 by a reciprocatingly moving position. No matter what type of feed device 1 is employed, a part of the conveying pipe is always filled with the material to form an air resistance, so as to prevent a gas in the roller 2 from leaking out of the roller 2 from the feed device 1, or prevent the air outside the roller 2 from entering the roller 2 from the feed device 1. For better sealing, a first gate valve 101 is arranged at the feed bin of the piston feeder and a second gate valve 102 is arranged in the conveying pipe of the piston feeder. During feeding, the second gate valve 102 is opened and the first gate valve 101 is closed (to prevent the material from being extruded upward and out of the conveying pipe to return to the feed bin when the piston pushes the material), and the piston is pushed by an air cylinder or an oil cylinder to move forward to convey the material into the rotary furnace through the straight-through rotary joint 18 and the conveying pipe; after the feeding is completed, the second gate valve 102 is closed (to prevent the material from returning when the piston retreats), the first gate valve 101 is opened, and the piston is pulled by the air cylinder or the oil cylinder to retreat, the material enters the conveying pipe of the piston feeder by opening a feed opening of the first gate valve 101.

The conveying pipe of the feed device 1 is rotatably sealed with the end face of the feed end of the roller 2, compared with the large-area sealing face surrounding one end of the roller at the furnace head in a conventional rotary furnace, according to the present application, a rotary sealing face between the feed device 1 and the roller 2 is small, only an ordinary packing seal or sealing ring is required to meet the sealing requirements, the sealing is simple, a sealing cost is reduced, and an air leakage does not easily occur, thus ensures the reaction quality of the material in the roller 2.

The above feed device 1 is also suitable for the eccentric oscillating rotary furnace, As for the in-roller eccentric oscillating rotary furnace, the structure and mounting manner of the feed device 1 are the same as those of the concentric oscillating rotary furnace; as for the out-roller eccentric oscillating rotary furnace, as shown in FIG. 9, the end face of the feed end of the roller 2 may extend to the rotational axis A, the feed inlet is opened in the end face, and the conveying pipe of the feed device 1 can be rotatably and sealingly connected to end face extending to the rotational axis A through the straight-through rotary joint 18; or the end face of the feed end of the roller 2 is connected to a pipe at a roller bottom at the feed end rather than extending to the rotational axis A, the pipe has a feed inlet, and the feed device is rotatably and sealingly connected to the feed inlet of the pipe, as long as the conveying axis of the feed device 1 coincides with the rotational axis A of the rotary furnace, which will not be described herein.

As shown in FIGS. 1 and 3, a discharge device 6 of the concentric oscillating rotary furnace is provided according to the present application, the discharge device 6 is a spiral discharge conveyor, a conveying pipe of the spiral discharge conveyor is rotatably and sealingly connected to the end face of the discharge end of the roller 2, and the conveying pipe coincides with the axis B of the roller 2; the roller material outlet 201 is arranged on the end face of the discharge end, the conveying pipe of the spiral discharge conveyor is fixed, and the roller 2 rotates with respect to the conveying pipe. A portion, located inside the roller 2, of the conveying pipe, is provided with a discharge groove at an upper portion thereof, the material is turned over in the roller 2, and enters the conveying pipe through the discharge groove, and is finally discharged out of the conveying pipe.

In this embodiment, for better realizing the technical treatment of the rotary furnace, the concentric oscillating rotary furnace further includes a heat exchange jacket and/or an electric heating device 20 arranged on the outer wall of the roller 2, the heat exchange jacket can be connected to external pipes and external devices through the movable duct assembly 5, a heat exchange medium enters and exits the heat exchange jacket through the movable duct assembly 5, and the heat exchange jacket utilizes a principle of heat transfer through a partition to perform heat treatment on the material in the roller 2, so as to transfer heat to the material in the roller 2. Or, the heat exchange jacket communicates with the roller 2 through a fixed pipe fixed on a roller wall of the roller 2, and the fixed pipe is fixed on the outer wall of the roller 2. The electric heating device 20 directly heats the material in the roller 2. The electric heating device 20 is connected to a second control device through wires, the second control device has a power control unit, and a power supply volume of the electric heating device 20 is controlled by the second control device. According to the technical requirements, the electric heating device 20 is turned on/off and/or the heat exchange medium is introduced into the heat exchange jacket, to control the temperature in the roller 2, so as to achieve the technical requirements.

The electric heating device 20 may be one of or a various combination of a heating wire heating device, a microwave heating device, an electromagnetic heating device, and a plasma heating device. According to the technical requirements, various electric heating devices 20 can be used in a random combination or separately.

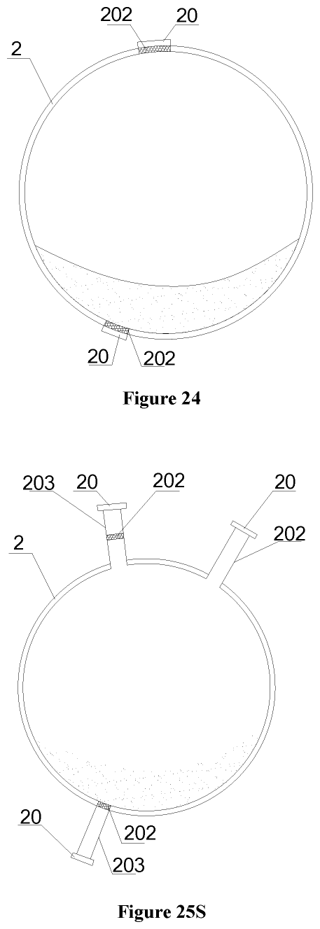

As shown in FIGS. 24 and 25, the electric heating device 20 preferably employs the microwave heating device, the mounting structure of the microwave heating device has two forms, one form is shown in FIG. 24, the microwave heating device is directly mounted on the roller wall, a material at a portion, used for mounting the microwave heating device, of a roller body is a high temperature resistant and wave-transparent material, that is, the portion, where the microwave heating device is required to be mounted, of the roller 2 is provided with a mounting hole in communication with the interior of the roller 2, and a high temperature resistant and wave-transparent layer 202 (such as a pottery brick, a silicon brick, heat-resistant fiberglass and the like) is sealingly mounted in the mounting hole. The high temperature resistant and wave-transparent layer 202 serves as a part of the roller body, an internal surface of the high temperature resistant and wave-transparent layer 202 is an internal surface of the roller 2, and the microwave heating device is mounted on an external surface of the high temperature resistant and wave-transparent layer 202, so that the microwave can pass through the roller wall and enter the roller 2 to heat the material. The microwave heating device is connected to the second control device through wires, for energizing the microwave heating device and controlling the heat supply volume. The mounting structure is suitable for heating in working conditions of low temperatures.

Another mounting structure of the microwave heating device is shown in FIG. 25. The microwave heating device is fixed on the roller wall of the roller 2 through a metal waveguide tube 203, that is, the roller wall of the roller 2 is provided with the metal waveguide tube 203 in communication with the interior of the roller 2, and the microwave heating device is fixed at an end, away from the roller wall, of the metal waveguide tube 203. The metal waveguide tube 203 is a metal tube having a closed tube wall, such as a circular tube, a square tube and the like, the microwave generated by the microwave heating device is transmitted to the interior of the roller 2 through a tube cavity of the metal waveguide tube 203, to heat the material. The metal waveguide tube 203 can prevent the microwave from leaking out, and the metal waveguide tube 203 separates the microwave heating device away from the roller wall of the roller 2, which can prevent the microwave heating device from being damaged by the heating of the roller wall of the roller 2. The mounting structure is suitable for heating in working conditions of low temperatures and high temperatures.

As an optimization shown in FIG. 25, in this embodiment, a high temperature resistant and wave-transparent layer 202 is arranged inside the metal waveguide tube 203, The high-temperature resistant and wave-transparent layer 202 blocks the metal waveguide tube 203 so that high temperature gases or high temperature solids in the roller 2 cannot come into contact with the microwave heating device through the metal waveguide tube 203, but the microwave can enter the interior of the roller 2 through the high-temperature resistant and wave-transparent layer 202. The high-temperature resistant and wave-transparent layer 202 may be a ceramic brick, a silicon brick, a magnesium brick, a high-alumina brick or the like. The high-temperature resistant and wave-transparent layer 202 may be arranged at any position inside the metal waveguide tube 203, such as a middle position, a position connected to the roller wall and so on, as long as high temperature gases and high temperature solids in the roller 2 can be blocked. The number of the high-temperature resistant and wave-transparent layer 202 is not limited herein, which may be one, two, three or more. The arrangement is suitable for heating in working conditions of high temperatures, which can further prevent the microwave heating device from being damaged by high temperatures.

By employing the microwave heating device, a local hotspot can be formed inside the material in the roller 2 by using an effect of a microwave field, and the material can better perform reactions due to a “hotspot effect”.

Further, in the embodiment, an insulating layer is arranged on both the heat exchange jacket and the outer wall of and the roller 2, to preserve heat for a heat treatment process of the roller 2.

As shown in FIGS. 1 and 3, in order to accurately detect and control the temperature and/or the pressure in the roller 2 and/or the heat exchange jacket, the concentric oscillating rotary furnace in this embodiment further includes a temperature sensor 8 and/or a pressure sensor arranged on the roller 2 and/or the heat exchange jacket, the temperature sensor 8 and/or the pressure sensor are connected to the second control device through wires, the temperature sensor 8 and/or the pressure sensor are arranged on the roller wall of the roller 2, and a temperature-sensing element thereof sticks into the roller 2. The second control device has a detection control unit, of course, the power control unit and the detection control unit of the second control device may separately belong to two different control devices. The second control device and the oscillation control device may be different devices, and may also be integrated in the same electric control cabinet 9. In a case that the second control device and the oscillation control device are integrated in the same electric control cabinet 9, the temperature sensor 8 and/or the pressure sensor are connected to the electric control cabinet 9 through wires, to monitor the temperature and/or pressure parameters at a position of each of radial sections in the interior of the roller 2 in an axial direction thereof and/or inside the heat exchange jacket. The temperature sensor 8 transmits the temperature parameters to the electric control cabinet 9, and the electric control cabinet 9, according to the temperature parameters at the position of each of radial sections in the roller 2 in the axial direction thereof and/or inside the heat exchange jacket monitored in real time by the temperature sensor 8, controls opening degrees of valves of the movable duct assembly 5, to control an amount of the fluid material or the heat source enters or exits the roller 2, besides, the electric control cabinet 9 controls a turning on/off operation of the electric heating device 20, to control the temperatures at each section inside the roller 2 and/or inside the heat exchange jacket, to meet the technical requirements of each reaction section and achieve an optimal reaction effect. The pressure sensor transmits the pressure parameters to the electric control cabinet 9, and the electric control cabinet 9, according to the pressure parameters inside the roller 2 and/or the heat exchange jacket monitored in real time by the pressure sensor, controls opening degrees of corresponding pneumatic valves and operation of a fan, so as to control the pressure inside the roller 2 and/or the heat exchange jacket. Since the roller 2 oscillates reciprocatingly only within a certain radian range, the temperature sensor 8 and/or the pressure sensor may be arranged on the roller 2 and/or the heat exchange jacket, and connected to the electric control cabinet 9 through wires, and the wires will not be wound around the roller 2, which facilitates the monitoring and control of the temperature and/or pressure parameters at the position of each of radial sections in the roller 2 in the axial direction thereof, and is more beneficial to the material treatment.

In order to facilitate the control of the pressure and the reaction temperature in the roller 2, the rotary furnace in this embodiment is provided with valves on the movable duct assembly 5 and/or the fixed pipes both for conducting gas, and the amount of the introduced gas is controlled by controlling the opening degrees of the corresponding valves, thus pressure and the reaction temperature in the roller 2 is controlled. Of course, the valves may not be provided.

As an optimization, the valves are manual valves and/or automatic valves, more preferably may be the automatic valves; the automatic valves may be pneumatic valves or electric valves, and the automatic valves are connected to the second control device through wires, for the automatic control of the opening degrees of the automatic valves.

As shown in FIG. 14, in this embodiment, the concentric oscillating rotary furnace further includes a number of partitions 14 arranged inside the roller 2, the partitions 14 are perpendicular to the axis of the roller 2, each of the partitions is provided with an opening, and the openings are located in a solid material moving region in the roller 2. Since the roller 2 oscillates reciprocatingly, the material moves reciprocatingly in a bottom region of the roller 2, this region is called the solid material moving region, namely a solid phase region. A purpose of arranging the partitions 14 is that, considering that some materials need to go through different technical treatments such as pyrolysis, gasification, carbonization, activation and so on when being heated, and the temperature required for each technical treatment is different, therefore, in order to better realize the treatment of the material, the roller 2 is separated into a number of temperature sections by the partitions 14 for different technical functions, so that an optimal material conversion effect can be achieved. Another purpose of arranging the partitions 14 is that, multiple partitions 14 are arranged in a same technical heating section (usually heated by the jacket), so that a temperature gradient with multiple temperature regions is formed in the same technical heating section, and a heating medium in the heat exchange jacket flows reversely with respect to the material in the interior of the roller 2 in the technical heating section, which can increase a heating temperature difference, thereby improving a heating efficiency and a heat energy utilization rate of the heating medium. Due to the opening arranged at a position, near a bottom portion of the roller 2, of the partition 14, the material can enter a next temperature reaction section through an interval between the partition 14 and the roller 2.

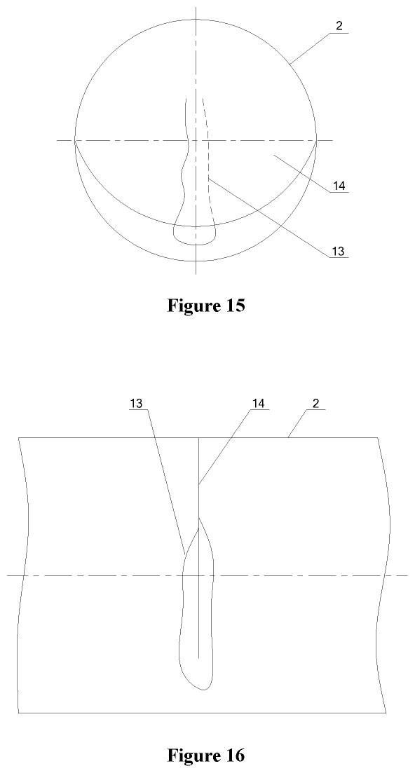

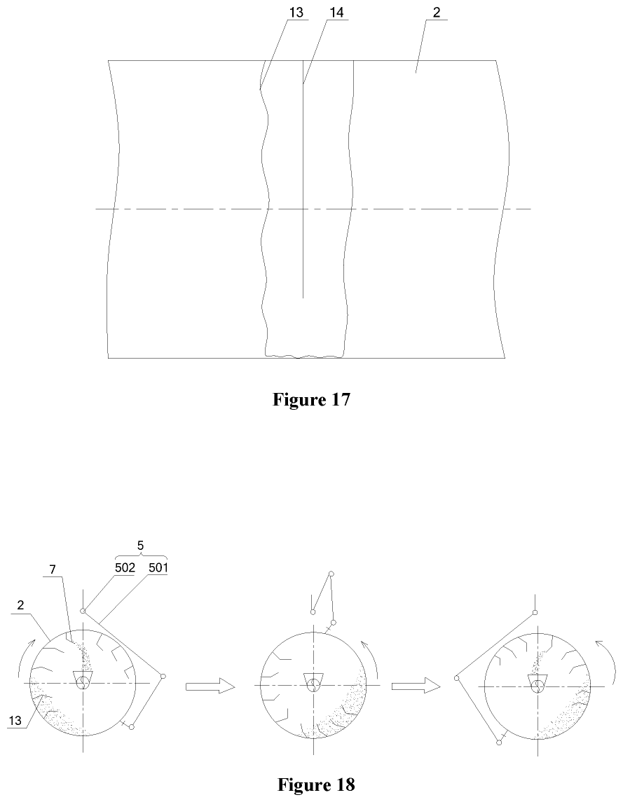

As shown in FIGS. 4 to 6, FIGS. 10, 12, 13 and FIGS. 15 to 18, the concentric oscillating rotary furnace further includes a movable chain 13 arranged in the roller 2, the movable chain 13 can be arranged on an inner wall of the roller 2, one end of the movable chain is fixed on the inner wall of the roller 2, another end of the movable chain is not fixed, or two ends are both fixed on the inner wall of the roller 2. With the reciprocating oscillation of the roller 2, the movable chains 13 continuously slides in the roller 2 with respect to a wall surface of the roller, on the one hand, the material attached to the wall surface can be cleaned, and on the other hand, the material can be pushed by the movable chain 13 to move toward the discharge end, which facilitates the conveying of the material. The movable chain 13 can also strengthen the heat transfer from the roller wall to the material. As shown in FIGS. 15 and 16, the movable chain 13 may also be arranged on the partition 14, two ends of the movable chain 13 are fixed on two plate surface of the partition 14 respectively, the movable chain 13 passes through the opening of the partition 14, with the reciprocating oscillation of the roller 2, the movable chain 13 can oscillate reciprocatingly at the opening, to prevent the partition 14 from being blocked. Of course, the two ends of the movable chain 13 passing through the partition 14 may also be fixed on the roller wall at an upper portion of the roller 2, as shown in FIG. 17, or one end of the movable chain 13 is fixed on the roller wall of the roller 2, another end of the movable chain 13 is fixed on a plate surface of the partition 14, the movable chain 13 passing through the opening of the partition 14 may be suspended, or may partially be in sliding contact with the inner wall of the roller 2, preferably be in sliding contact with the inner wall of the roller 2, to prevent the material from attaching to the wall, thereby improving the heat transfer efficiency. Of course, the mounting form of the movable chain 13 is not limited to the forms listed in this embodiment.

As shown in FIGS. 1, 3, 18 and 23, in order to facilitate the discharge of the material from the discharge device 6, the concentric oscillating rotary furnace in the embodiment further includes a turnover plate 7 arranged on the inner wall of the roller 2 and located in the solid material moving region of the roller 2. The number of the turnover plate 7 may be one, two, three or more, when there are multiple turnover plates 7, the turnover plates 7 are arranged in such a manner that when the rotary furnace is not in operation, the roller 2 is in a naturally stationary state, the multiple turnover plates 7 in a same cross section of the roller are symmetrically arranged with respect to a vertical radial direction of the cross section, and the turnover plates 7 are reversely and upward bent, so that each of the symmetrically arranged turnover plates 7 can turn over the material when the roller 2 rotates to a half side where the turnover plate itself is located, and the material is raised and scattered, so that the solid material comes into full contact with and react with a reaction gas in the roller 2. The turnover plates 7 arranged near the discharge device 6 can also turn over and guide the solid material into the discharge device 6. The turnover plates 7 can be arranged at each technical section in the axial direction of the roller 2, and the number of the turnover plates 7 is determined according to the requirements.

As for the eccentric oscillating rotary furnace, the turnover plates 7 may not be bent, or bending directions are symmetrically arranged in a same radial cross section.

The concentric oscillating rotary furnace is described hereinbefore, and the eccentric oscillating rotary furnace will be described hereinafter. As shown in FIGS. 4 to 10 and FIG. 22, in the eccentric oscillating rotary furnace, except that the shape of the roller 2, the discharge device 6, the drive device, the support device, and the movable duct assembly 5 are different from those of the concentric oscillating rotary furnace, other structures may all employ the structures in the concentric oscillating rotary furnace, which will not be described herein.

A shape of the cross section of the roller 2 of the eccentric oscillating rotary furnace may be a circular shape, an oval shape or the like, and the two ends of the roller 2 are closed. When the rotational axis A of the eccentric oscillating rotary furnace is located below the exterior of the roller 2, the end face of the feed end of the roller 2 may extend to the rotational axis A or may not extend to the rotational axis A, and the end face of the discharge end of the roller 2 may extend to the rotational axis A or may not extend to the rotational axis A. The eccentric oscillating rotary furnace is provided with a weight balancing block 15, so that a gravity center of the entire eccentric oscillating rotary furnace is as close as possible to the rotational axis A of the eccentric oscillating rotary furnace. Preferably, the weight balancing weight 15 and the gravity center of the roller 2 may be, or may not be arranged symmetrically with respect to the rotational axis, to provide gravity and the inertia force to balance the roller 2 when the roller 2 is oscillating, so that the oscillation of the roller 2 is more effortless and smooth.

As shown in FIG. 4, specifically, a drive device and a support device of the eccentric oscillating rotary furnace is provided according to the embodiment, the drive device is an eccentric wheel gear and ring gear drive device, and the support device is a support roller support device. Since the support roller support device is only suitable for the out-roller eccentric oscillating rotary furnace, the drive device and the support device combined with the support roller support device are only suitable for the out-roller eccentric oscillating rotary furnace. The eccentric wheel gear and ring gear drive device includes a ring gear 4, a drive gear 11 and a powered component 10, the ring gear 4 is fixed on the outer wall of the roller 2, and the axis of the ring gear 4 coincides with the rotational axis A of the eccentric oscillating rotary furnace, the ring gear 4 meshes with drive gear 11, and the drive gear 11 is transmissionly connected to the powered component 10. The powered component 10 is the same as the powered component 10 of the concentric oscillating rotary furnace, which will not be described herein. The powered component 10 is connected to the oscillation control device through wires, the oscillation control device controls the rotating direction of the powered component 10, the powered component 10 drives the drive gear 11 to rotate, and the drive gear 11 drives the ring gear 4 and the roller 2 to oscillate reciprocatingly around the rotational axis A of the eccentric oscillating rotary furnace. The support roller support device includes at least two sets of support frames 17 and support rollers 16, wherein the support frames 17 are fixed, the support rollers 16 are rotatably connected to the support frames 17, and a rotational axis of each of the support rollers 16 coincides with the rotational axis A of the eccentric oscillating rotary furnace; the bottom portion of the roller 2 is fixedly connected to the support rollers 16, and the weight balancing block 15 is fixed on each of the support rollers 16. Preferably, the centroid axis of the weight balancing block 15 and the centroid axis of the roller 2 are arranged symmetrically with respect to the rotational axis A of the eccentric oscillating rotary furnace, and the two sets of support frames 17 and support rollers 16 are preferably arranged near the two ends of the roller 2 respectively, so that the supporting is more stable.

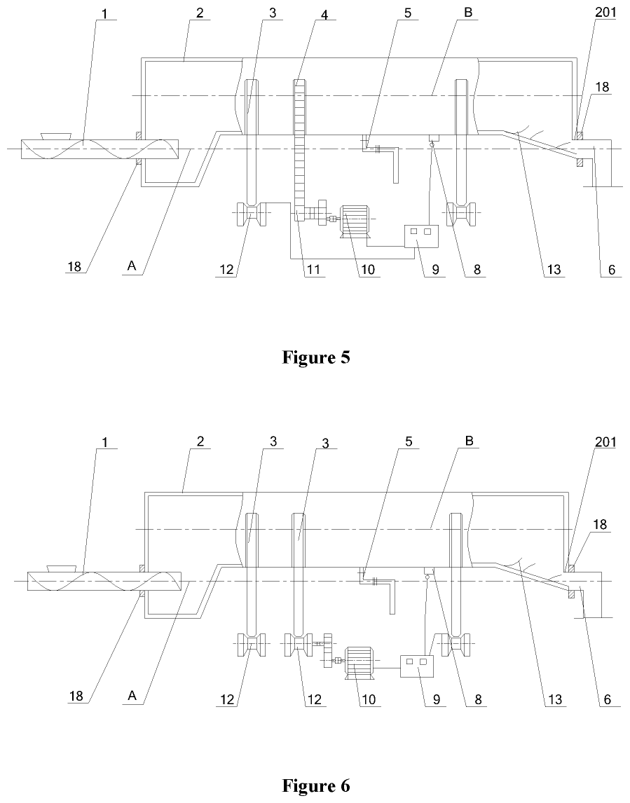

As shown in FIG. 5, another type of drive device and support device of the eccentric oscillating rotary furnace is provided according to the embodiment, the drive device is an eccentric wheel gear and ring gear drive device, the support device is an eccentric riding wheel and riding ring support device, and a combination of the drive device and the support device is suitable for the in-roller eccentric oscillating rotary furnace and the out-roller eccentric oscillating rotary furnace. The eccentric wheel gear and ring gear drive device includes a ring gear 4, a drive gear 11 and a powered component 10. In this embodiment, the eccentric wheel gear and ring gear drive device is the same as the eccentric wheel gear and ring gear drive device in FIG. 4, which will not be described herein. The eccentric riding wheel and riding ring support device includes at least two sets of riding rings 3 and riding wheels 12, each of the riding rings 3 is fixed on the peripheral wall of the roller 2, and the axis of each of the riding rings 3 coincides with the rotational axis A of the eccentric oscillating rotary furnace; each of the riding rings 3 is in contact with and supports at least one riding wheel 12, for supporting the rotation of the riding ring 3. Each of the riding rings 3 is provided with the weight balancing block 15, preferably, the centroid axis of the weight balancing block 15 and the centroid axis of the roller 2 are arranged symmetrically with respect to the rotational axis A of the eccentric oscillating rotary furnace. As shown in FIGS. 5 and 7, the ring gear and the riding rings may be partial-circle structures or full-circle structures, that is, the ring gear 4 and the riding rings 3 are circular plate structures, and an arc-shaped notch or a circular hole for inserting the roller 2 is machined in circular plates. Outer edges of the ring gear 4 and the riding rings 3 exceed the axis of the roller 2 and approach or exceed an edge of the roller 2, to increase the fixing strength.

As shown in FIG. 6, a third type of drive device and support device of the eccentric oscillating rotary furnace is provided according to the embodiment, the drive device is an eccentric riding wheel and riding ring drive device, the support devices are multiple sets of eccentric riding wheel and riding ring support devices, which are at least two sets, and the combination of the drive device and the support devices is suitable for the in-roller eccentric oscillating rotary furnace and the out-roller eccentric oscillating rotary furnace. Each set of the eccentric riding wheel and riding ring support devices includes a riding ring 3 and a riding wheel 12, the riding ring 3 is fixed on the peripheral wall of the roller 2, and the axis of the riding ring 3 coincides with the rotational axis A of the eccentric oscillating rotary furnace; the riding wheel 12 is in contact with and supports an outer ring surface of the riding ring 3, and an axis of the riding wheel 12 is fixed for rotatably supporting the riding ring 3; the outer ring surface of one riding ring 3 is preferably in contact with and supports two riding wheels 12, more preferably, the support device includes two sets of riding rings 3 and riding wheels 12, the two sets of riding rings 3 and riding wheels 12 are located at the two ends of the roller 2 respectively, thus the supporting is more stable. The eccentric riding wheel and riding ring drive device includes a riding ring 3, a riding wheel 12 and a powered component 10, the powered component 10 is transmissionly connected to the riding wheel 12, the powered component 10 drives the riding wheel 12 to rotate reciprocatingly, and the riding ring 3 is driven by the static fraction between the riding wheel 12 and the riding ring 3 to oscillate reciprocatingly, and then the roller 2 oscillates reciprocatingly. Each of the riding rings 3 is provided with the weight balancing block 15, preferably, the centroid axis of the weight balancing block 15 and the centroid axis of the roller 2 are arranged symmetrically with respect to the rotational axis A of the eccentric oscillating rotary furnace.

As shown in FIG. 7, a fourth type of drive device and support device of the eccentric oscillating rotary furnace is provided according to the embodiment, the drive device is an eccentric pushrod drive device, the support device is an eccentric riding wheel and riding ring support device, and the combination of the drive device and the support device is suitable for the out-roller eccentric oscillating rotary furnace and the in-roller eccentric oscillating rotary furnace. The eccentric riding wheel and riding ring support device includes at least two sets of riding rings 3 and riding wheels 12, each of the riding rings 3 is fixed on the peripheral wall of the roller 2, and the axis of each of the riding rings 3 coincides with the rotational axis A of the eccentric oscillating rotary furnace; the outer ring surface of each of the riding rings 3 is in contact with and supports at least one riding wheel 12, for supporting the rotation of the riding ring 3. Each of the riding rings 3 is provided with the weight balancing block 15, preferably, the centroid axis of the weight balancing block 15 and the centroid axis of the roller 2 are arranged symmetrically with respect to the rotational axis A of the eccentric oscillating rotary furnace. The eccentric pushrod drive device includes a telescopic cylinder 19, preferably, there are two telescopic cylinders 19 arranged symmetrically at two sides of the roller 2, an end portion of the telescopic rod of each of the telescopic cylinders 19 is hinged to the riding ring 3, and the fixed end of each of the telescopic cylinders 19 hinged to the fixed table; two points, hinged to the riding ring 3, of the telescopic rods of the two telescopic cylinders 19 are symmetrical with respect to a vertical radial direction of the riding ring 3, and two hinge points of the fixed ends of the two telescopic cylinders 19 with the fixed table are located at a same horizontal line. The riding ring 3 is driven by the alternate extension/contraction of the two telescopic cylinders 19 to rotate reciprocatingly, and then the roller 2 is driven to rotate reciprocatingly. Of course, the number of the telescopic cylinder 19 may also be one, two, three or more; the position of the telescopic cylinder 19 is arranged according to actual requirements, as long as the reciprocating oscillation of the roller 2 can be ensured.

As shown in FIG. 8, a fifth type of drive device and support device of the eccentric oscillating rotary furnace is provided according to the embodiment, the drive device is an eccentric pushrod drive device, and the support device is a support roller support device. Since the support device employs the support roller support device, the combination of the drive device and the support device is only suitable for the out-roller eccentric oscillating rotary furnace. The support roller support device includes at least two sets of support frames 17 and support rollers 16, which is the same as the support roller support device in FIG. 7, and will not be described herein. The weight balancing block 15 is fixed on the support roller 16, preferably, the centroid axis of the weight balancing block 15 and the centroid axis of the roller 2 are arranged symmetrically with respect to the rotational axis A of the eccentric oscillating rotary furnace. The eccentric pushrod drive device includes a hinge frame 21 and at least one telescopic cylinder 19, preferably, there are two telescopic cylinders 19 arranged symmetrically at the two sides of the roller 2, the hinge frame 21 is fixed to the support roller 16, the telescopic rods of the two telescopic cylinders 19 are hinged to two ends of the hinge frame respectively, to increase the torque by the hinge frame 21; the fixed end of each of the telescopic cylinders 19 is hinged to the fixed table, and two hinge points of the fixed ends of the two telescopic cylinders 19 with the fixed table are located at the same horizontal line. The support roller 16 is driven by the alternate extension/contraction of the two telescopic cylinders 19 to rotate reciprocatingly, and then the roller 2 is driven to rotate reciprocatingly. Of course, the number of the telescopic cylinder 19 may also be one, three or more, the position of the telescopic cylinder 19 is arranged according to actual requirements, as long as the reciprocating oscillation of the roller 2 can be ensured.

In this embodiment, the telescopic cylinder 19 may be an electric telescopic cylinder, a hydraulic telescopic cylinder or a pneumatic telescopic cylinder. The telescopic cylinder 19 is connected to the control device, and the control device controls the extension/contraction of the telescopic cylinder 19, to achieve the reciprocating oscillation of the roller 2.

In this embodiment, the oscillation control device of the eccentric oscillating rotary furnace may be the same as the oscillation control device of the concentric oscillating rotary furnace. A rotation direction of the powered component 10 is controlled by the position sensor and the electric control cabinet 9, or the extension/contraction direction and the travel of the telescopic cylinder 19 are controlled by the electric control cabinet 9, to achieve the reciprocating oscillation of the roller 2; or the rotation direction and the revolution number of the rotation in a single direction are automatically controlled only by the program of the control device, or the extension/contraction direction and the travel of the telescopic cylinder 19 are controlled by the program, to realize the control of the radian of the reciprocating oscillation of the roller 2. The radian of the reciprocating oscillation of the eccentric oscillating rotary furnace generally ranges from 60° to 270°, and the optimal angle ranges from 120° to 210°.

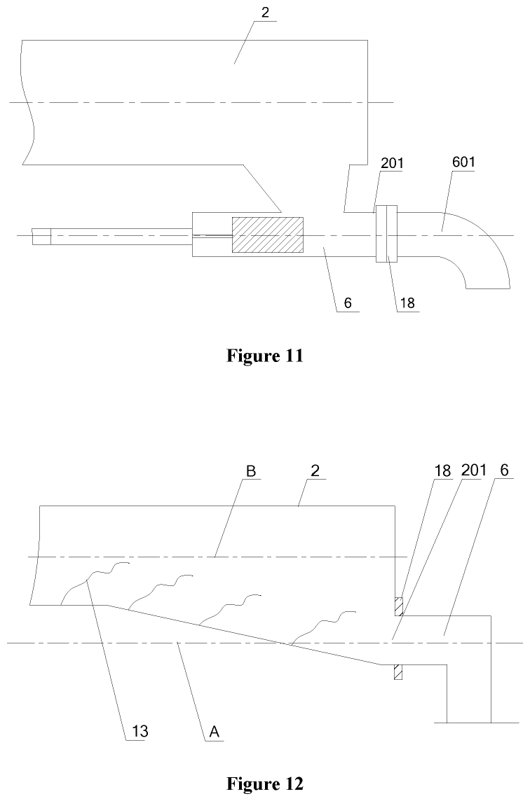

As shown in FIGS. 10 to 13, three types of discharge devices 6 of the eccentric oscillating rotary furnace are provided according to the embodiment. The discharge device 6 of the in-roller eccentric oscillating rotary furnace employs the same spiral discharge conveyor as the concentric oscillating rotary furnace. In order to facilitate the material discharge, the turnover plate 7 is arranged in the solid material moving region, near the spiral discharge conveyor, in the roller 2. Except that the out-roller eccentric oscillating rotary furnace can employ the same spiral discharge conveyor as the concentric oscillating rotary furnace, the discharge device 6 of the out-roller eccentric oscillating rotary furnace may also be a piston discharger or a discharge pipe. As shown in FIG. 10, the discharge device 6 of the out-roller eccentric oscillating rotary furnace is the spiral discharge conveyor, the conveying pipe, located outside the roller, of the spiral discharge conveyor is rotatably and sealingly connected to the end face, extending to the rotational axis A, of the discharge end of the roller 2 through the straight-through rotary joint 18, in this case, the roller material outlet 201 is arranged on the extending end face of the discharge end; or, the end face of the discharge end of the roller 2 does not extend to the rotational axis A, the conveying pipe of the spiral discharge conveyor is rotatably and sealingly connected to a pipe arranged on the roller wall of the solid phase region at the discharge end through the straight-through rotary joint 18, and the roller material outlet 201 is a pipe orifice of the pipe. As shown in FIG. 11, the discharge device 6 of the out-roller eccentric oscillating rotary furnace is the piston discharger, the conveying pipe of the piston discharger communicates with the roller body at the discharge end of the roller 2, and a conveying axis of the piston discharger coincides with the rotational axis A of the out-roller eccentric oscillating rotary furnace. An outlet of the conveying pipe of the piston discharger is rotatably and sealingly connected to an external fixed discharge pipe 601 through the straight-through rotary joint 18, and the roller material outlet 201 is the outlet of the conveying pipe of the piston discharger. A movable chain 13 is arranged on an inner wall of the roller body, near the discharge end, of the roller 2, a portion, connected to the discharge device 6, of the roller bottom of the roller 2 is a slope, the material slides into the discharge device 6 through the slope, and finally be discharged.

As shown in FIG. 12, another type of discharge device 6 of the out-roller eccentric oscillating rotary furnace is the discharge pipe, two arrangement forms of the discharge pipe are listed according to the embodiment, one arrangement form is that the end face of the discharge end of the roller 2 extends to the rotational axis A, the roller material outlet 201 is opened on the end face of the discharge end of the roller 2, the roller material outlet 201 is arranged near a lower portion of the end face of the discharge end, and the axis of the roller material outlet 201 coincides with the rotational axis A of the out-roller eccentric oscillating rotary furnace. The roller wall of the solid phase region of the roller 2 is transitively connected to the roller material outlet 201 by the slope, to facilitate the sliding of the solid material toward the drum material outlet 201 along the slope. The discharge pipe and the roller material outlet 201 are rotatably and sealingly connected, and may be connected through the straight-through rotary joint 18, the discharge pipe is a bent pipe and is bent downward at a right angle, and the movable chain 13 is arranged on the slope and/or the discharge pipe. With the oscillation of the movable chain 13, the material is conveyed to the roller material outlet 201, and discharged from the discharge pipe.

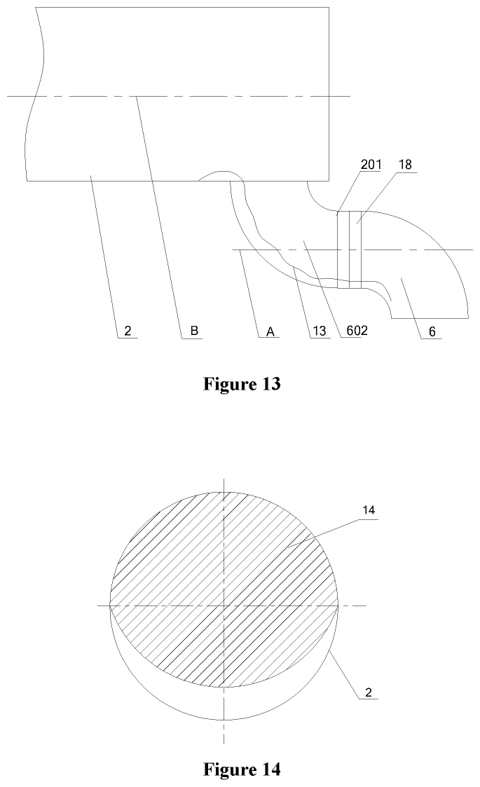

Another arrangement form of the discharge pipe is as shown in FIG. 13, the end face of the discharge end of the roller 2 does not extend to the rotational axis A, an unloading opening is opened on the roller wall, in a solid phase region near the discharge end, of the roller 2, the unloading opening is connected to an unloading pipe 602. The discharge pipe and an outlet of the unloading pipe 602 are rotatably and sealingly connected, and may specially be connected through the straight-through rotary joint 18, the roller material outlet 201 is the outlet of the unloading pipe 602, and a rotational axis of the discharge pipe coincides with the rotational axis A of the out-roller eccentric oscillating rotary furnace. The arrangement form is not limited to those listed in this embodiment, as long as the discharge of the out-roller eccentric oscillating rotary furnace can be realized.

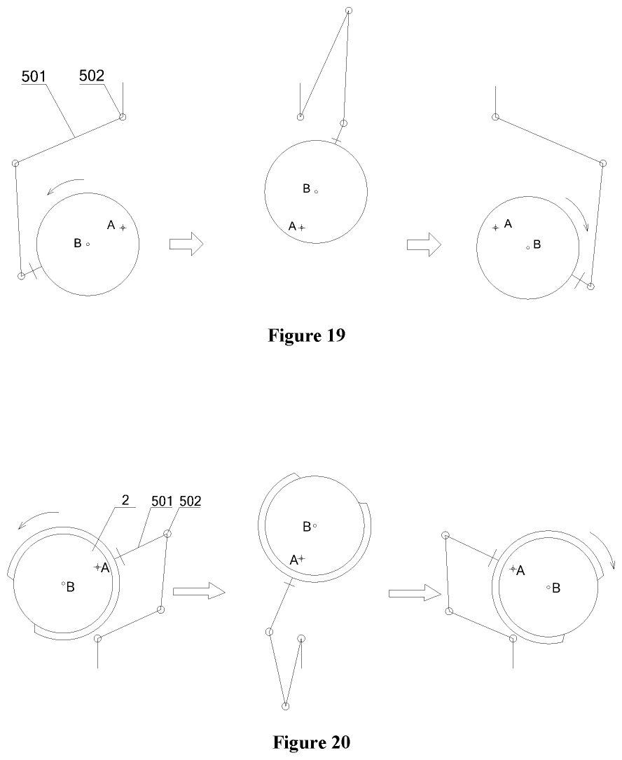

As shown in FIGS. 18 and 19, in the eccentric oscillating rotary furnace, in a case that the movable duct assembly 5 employs the sub-pipes 501 and the rotary joint 502, when the movable duct assembly 5 is arranged at the lower portion of the roller 2, the arrangement form of the sub-pipes 501 and the short adapter pipe on the roller 2 is as follows. The rotary joint 502 connected to the external pipe is always located vertically below the rotational axis A of the out-roller eccentric oscillating rotary furnace, and when the short adapter pipe moves to a lowest end of the roller 2, the rotational axis of the rotary joint 502 in the short adapter pipe coincides with the rotational axis of the rotary joint 502 connected to the external pipe, thus can better prevent the sub-pipes 501 from colliding with the roller 2 during rotation. When the movable duct assembly 5 is arranged at the upper portion of the roller 2, the rotary joint 502 connected to the external pipe is always located vertically above the rotational axis A, thus similarly can better prevent the sub-pipes 501 from colliding with the roller 2.

The above roller 2 of the rotary furnace is preferably made of heat resistant steel, or may not be made of heat resistant steel, and a suitable manufacturing material is chosen according to the specific technique and usage. The rotary furnace according to the present application has a good sealing performance, a good production environment, a high automation degree and the accurate temperature control, the start-up and operation of the system can be automated, and the production of 24-hour continuous material feed and discharge can be achieved.

The above embodiments in this specification are described in a progressive manner. Each of the embodiments is mainly focused on describing its differences from other embodiments, and references may be made among these embodiments with respect to the same or similar portions among these embodiments.

Based on the above description of the disclosed embodiments, those skilled in the art are capable of carrying out or using the present application. It is obvious for those skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. A rotary furnace, comprising a roller, wherein an end face of each of a feed end and a discharge end of the roller is a closed end face, and the feed end is higher than the discharge end, and the rotary furnace further comprises:
a feed device rotatably and sealingly communicating with a feed inlet at the feed end of the roller, wherein a cross-sectional area of the feed inlet is smaller than the cross-sectional area of the feed end, and an axis of the feed inlet coincides with a rotational axis of the rotary furnace;
a discharge device communicatedly arranged at the discharge end of the roller, wherein a roller material outlet is at a position rotatably and sealingly cooperating with the discharge device, a cross-sectional area of the roller material outlet is smaller than a cross-sectional area of the discharge end, and an axis of the roller material outlet coincides with the rotational axis of the rotary furnace;
a drive device arranged outside the roller, and configured to drive the roller to oscillate reciprocatingly around the rotational axis of the rotary furnace;
a support device arranged outside the roller, and configured to rotatably support the roller to oscillate reciprocatingly around the rotational axis of the rotary furnace; and
an oscillation control device connected to the drive device through wires, and configured to control the drive device to motion, to control a radian and frequency of the reciprocating oscillation of the roller
a movable duct assembly communicatedly arranged on the roller and configured to allow a fluid material or a heat source to enter and exit the roller.

2. (canceled)

3. The rotary furnace according to claim 1, wherein the rotary furnace is a concentric oscillating rotary furnace or an eccentric oscillating rotary furnace; a rotational axis of the concentric oscillating rotary furnace coincides with the axis of the roller; the eccentric oscillating rotary furnace is an in-roller eccentric oscillating rotary furnace or an out-roller eccentric oscillating rotary furnace, a rotational axis of the in-roller eccentric oscillating rotary furnace lies inside the roller and does not coincide with the axis of the roller, and a rotational axis of the out-roller eccentric oscillating rotary furnace lies outside the roller; the axis of the roller oscillates reciprocatingly around a rotational axis of the eccentric oscillating rotary furnace and wherein the eccentric oscillating rotary furnace is further provided with a weight balancing block.

4. (canceled)

5. The rotary furnace according to claim 3, wherein a drive device of the concentric oscillating rotary furnace is a concentric wheel gear and ring gear drive device, and a support device of the concentric oscillating rotary furnace is a concentric riding wheel and riding ring support device;
the concentric wheel gear and ring gear drive device comprises:
a ring gear fixed on a peripheral wall of the roller, wherein an axis of the ring gear coincides with the axis of the roller;
a drive gear meshing with the ring gear; and
a powered component transmissionly connected to the drive gear;
the concentric riding wheel and riding ring support device comprises:
a riding ring fixed on the peripheral wall of the roller, wherein an axis of the riding ring coincides with the axis of the roller; and
a riding wheel in contact with and supporting an outer ring surface of the riding ring, wherein an axis of the riding wheel is fixed, and the riding wheel is configured to rotatably support the riding ring.

6. The rotary furnace according to claim 3, wherein the drive device of the concentric oscillating rotary furnace is a concentric pushrod drive device, and the support device of the concentric oscillating rotary furnace is a concentric riding wheel and riding ring support device;
the concentric riding wheel and riding ring support device comprises:
a riding ring fixed on the peripheral wall of the roller, wherein the axis of the riding ring coincides with the axis of the roller; and
a riding wheel in contact with and supporting the outer ring surface of the riding ring, wherein the axis of the riding wheel is fixed, and the riding wheel is configured to rotatably support the riding ring;
the concentric pushrod drive device comprises at least a telescopic cylinder, a telescopic rod of the telescopic cylinder is hinged to the roller, a fixed end of the telescopic cylinder is hinged to a fixed table, and the roller is driven by the extension and contraction of the telescopic cylinder to oscillate reciprocatingly.

7. The rotary furnace according to claim 3, wherein the drive device of the concentric oscillating rotary furnace is at least a set of concentric riding wheel and riding ring drive device, and the support devices of the concentric oscillating rotary furnace are a plurality of sets of concentric riding wheel and riding ring support devices;
each set of the concentric riding wheel and riding ring drive device comprises:
a riding ring fixed on the peripheral wall of the roller, wherein the axis of the riding ring coincides with the axis of the roller;
a riding wheel in contact with and supporting the outer ring surface of the riding ring, wherein the axis of the riding wheel is fixed, and the riding wheel is configured to rotatably support the riding ring; and
a powered component transmissionly connected to the riding wheel;
each set of the concentric riding wheel and riding ring support devices comprises:
a riding ring fixed on the peripheral wall of the roller, wherein the axis of the riding ring coincides with the axis of the roller;
and a riding wheel in contact with and supporting the outer ring surface of the riding ring, wherein the axis of the riding wheel is fixed, and the riding wheel is configured to rotatably support the riding ring.

8. The rotary furnace according to claim 3 wherein a drive device of the out-roller eccentric oscillating rotary furnace is an eccentric wheel gear and ring gear drive device, and a support device of the eccentric oscillating rotary furnace is a support roller support device;
the eccentric wheel gear and ring gear drive device comprises:
a ring gear fixed on the peripheral wall of the roller, wherein the axis of the ring gear coincides with the rotational axis of the eccentric oscillating rotary furnace;
a drive gear meshing with the ring gear; and
a powered component transmissionly connected to the drive gear;
the support roller support device comprises:
a support frame fixed in position; and
a support roller rotatably connected to the support frame, wherein an axis of the support roller coincides with the rotational axis of the eccentric oscillating rotary furnace, and two ends of the support roller are fixedly connected to a bottom portion of the roller and the weight balancing block respectively.

9. The rotary furnace according to claim 3, wherein a drive device of the eccentric oscillating rotary furnace is an eccentric wheel gear and ring gear drive device, and a support device of the eccentric oscillating rotary furnace is an eccentric riding wheel and riding ring support device;
the eccentric wheel gear and ring gear drive device comprises:
a ring gear fixed on the peripheral wall of the roller, wherein the axis of the ring gear coincides with the rotational axis of the eccentric oscillating rotary furnace;
a drive gear meshing with the ring gear; and
a powered component transmissionly connected to the drive gear;
the eccentric riding wheel and riding ring support device comprises:
a riding ring fixed on the peripheral wall of the roller, wherein an axis of the riding ring coincides with the rotational axis of the eccentric oscillating rotary furnace, and the weight balancing block is fixed on the riding ring; and
a riding wheel in contact with and supporting the outer ring surface of the riding ring, wherein the axis of the riding wheel is fixed, and the riding wheel is configured to rotatably support the riding ring.

10. The rotary furnace according to claim 3, wherein the drive device of the eccentric oscillating rotary furnace is an eccentric pushrod drive device, and the support device of the eccentric oscillating rotary furnace is an eccentric riding wheel and riding ring support device;
the eccentric riding wheel and riding ring support device comprises:
a riding ring fixed on the peripheral wall of the roller, wherein the axis of the riding ring coincides with the axis of the roller, and the weight balancing block is fixed on the riding ring; and
a riding wheel in contact with and supporting the outer ring surface of the riding ring, wherein the axis of the riding wheel is fixed, and the riding wheel is configured to rotatably support the riding ring;
the eccentric pushrod drive device comprises at least one telescopic cylinder, the telescopic rod of the telescopic cylinder is hinged to the riding ring, the fixed end of the telescopic cylinder is hinged to the fixed table, and the riding ring is driven by the extension and contraction of the telescopic cylinder to oscillate reciprocatingly.

11. The rotary furnace according to claim 3, wherein the drive device of the out-roller eccentric oscillating rotary furnace is an eccentric pushrod drive device, and the support device of the eccentric oscillating rotary furnace is an support roller support device;
the support roller support device comprises:
a support frame fixed in position; and
a support roller rotatably connected to the support frame, wherein the axis of the support roller coincides with the rotational axis of the eccentric oscillating rotary furnace, and two ends of the support roller are fixedly connected to the bottom portion of the roller and the weight balancing block respectively;
the eccentric pushrod drive device comprises:
a hinge frame fixed on the support roller;
and at least one telescopic cylinder, the telescopic rod of the telescopic cylinder is hinged to the hinge frame, the fixed end of the telescopic cylinder is hinged to the fixed table, and the support roller is driven by the extension and contraction of the telescopic cylinder to oscillate reciprocatingly.

12. The rotary furnace according to claim 3, wherein the drive device of the eccentric oscillating rotary furnace is an eccentric riding wheel and riding ring drive device, and the support devices of the concentric oscillating rotary furnace are a plurality of sets of eccentric riding wheel and riding ring support devices;
the eccentric riding wheel and riding ring drive device comprises:
a riding ring fixed on the peripheral wall of the roller, wherein the axis of the riding ring coincides with the rotational axis of the eccentric oscillating rotary furnace, and the weight balancing block is fixed on the riding ring;
a riding wheel in contact with and supporting the outer ring surface of the riding ring, wherein the axis of the riding wheel is fixed, and the riding wheel is configured to rotatably support the riding ring; and
a powered component transmissionly connected to the riding wheel; each set of the eccentric riding wheel and riding ring support devices comprises:
a riding ring fixed on the peripheral wall of the roller, wherein the axis of the riding ring coincides with the rotational axis of the eccentric oscillating rotary furnace, and the weight balancing block is fixed on the riding ring; and
a riding wheel in contact with and supporting the outer ring surface of the riding ring, wherein the axis of the riding wheel is fixed, and the riding wheel is configured to rotatably support the riding ring.

13. The rotary furnace according to claim 1, wherein the movable duct assembly is a hose; or the movable duct assembly is formed by connecting at least two sub-pipes head-to-tail through a rotary joint; or the movable duct assembly is a fixed oscillating pipe, one end of the fixed oscillating pipe is fixedly connected to an outer wall of the roller, another end of the fixed oscillating pipe is rotatably connected to an external pipe through the rotary joint, and a rotational axis of the rotary joint coincides with the rotational axis of the rotary furnace.

14. The rotary furnace according to claim 1, wherein the feed device is a spiral feed conveyor or a piston feeder, a conveying pipe of each of the spiral feed convey and the piston feeder is rotatably and sealingly connected to the feed inlet at the feed end of the roller, and a conveying axis of each of the spiral feed convey and the piston feeder coincides with the rotational axis of the rotary furnace.

15. The rotary furnace according to claim 1, wherein the discharge device (6) is a spiral discharge conveyor, a conveying pipe of the spiral discharge conveyor is rotatably and sealingly connected to the roller material outlet at the discharge end of the roller, and a conveying axis of the spiral discharge conveyor coincides with the rotational axis of the rotary furnace;
the discharge device of the out-roller eccentric oscillating rotary furnace is a piston discharger or a discharge pipe; a conveying pipe of the piston discharger is in communication with the discharge end of the roller, an outlet of the conveying pipe of the piston discharger is rotatably and sealingly connected to an external fixed discharge pipe, and a conveying axis of the piston discharger coincides with the rotational axis of the out-roller eccentric oscillating rotary furnace;
the discharge pipe is rotatably and sealingly connected to the roller material outlet arranged on the end face of the discharge end of the roller, a roller body, of a solid phase region near the discharge end, of the roller is connected to the roller material outlet through a slope, and an axis of the discharge pipe coincides with the rotational axis of the out-roller eccentric oscillating rotary furnace; or
a roller wall of the solid phase region at the discharge end of the roller is provided with an unloading pipe, the roller material outlet is an outlet of the unloading pipe, the discharge pipe is rotatably and sealingly connected to the roller material outlet, and the axis of the discharge pipe coincides with the rotational axis of the out-roller eccentric oscillating rotary furnace.

16. (canceled)

17. The rotary furnace according to claim 1, wherein the oscillation control device comprises a position sensor and an electric control cabinet both connected through wires, the position sensor is fixed on the support device or the roller, and the drive device is connected to the electric control cabinet through wires.

18. The rotary furnace according to claim 1, further comprising a heat exchange jacket and/or an electric heating device arranged on the roller, the heat exchange jacket is connected to an external device through the movable duct assembly, or the heat exchange jacket is in communication with an interior of the roller through a fixed pipe fixed on the roller wall of the roller; the electric heating device is connected to a second control device through wires, to control a power supply volume of the electric heating device; wherein the electric heating device is one of or a various combination of a heating wire heating device, a microwave heating device, an electromagnetic heating device, and a plasma heating device.

19. (canceled)

20. The rotary furnace according to claim 18, wherein the microwave heating device is fixed at an outer side of the roller wall of the roller through a high temperature resistant and wave-transparent layer or a metal waveguide tube, and the high temperature resistant and wave-transparent layer is in contact with the interior of the roller, and the metal waveguide tube is in communication with the interior of the roller and wherein the high temperature resistant and wave-transparent layer configured to partition the metal waveguide tube is further arranged inside the metal waveguide tube.

21. (canceled)

22. The rotary furnace according to claim 18, further comprising a plurality of temperature sensors and/or pressure sensors arranged at the roller and/or the heat exchange jacket, wherein the temperature sensors and/or the pressure sensors are connected to the second control device through wires, to monitor temperature and/or pressure parameters at a position of each of radial sections in the interior of the roller (2) in an axial direction thereof and/or inside the heat exchange jacket.

23. The rotary furnace according to claim 22, wherein valves are arranged in the movable duct assembly and/or the fixed pipe, wherein the valves are manual valves and/or automatic valves, the automatic valves is connected to the second control device through wires, for control of opening degrees of the automatic valves.

24. (canceled)

25. The rotary furnace according to claim 1, further comprising a plurality of partitions fixed in the roller, wherein the partitions are perpendicular to the axis of the roller, each of the partitions is provided with an opening, and the openings are located in a solid material moving region in the roller, it further comprises a plurality of movable chains arranged in the roller, wherein an end portion of each of the movable chains is fixed on an inner wall of the roller and/or the partition, and the plurality of movable chains pass through the openings of the partitions.

26. (canceled)

27. The rotary furnace according to claim 1, further comprising a plurality of turnover plates fixed on the inner wall of the roller and located in the solid material moving region of the roller, wherein the turnover plates are configured to turn over a solid material to make the solid material to come into full contact with a gaseous phase; and the turnover plate near the discharge device can turn over and guide the solid material into the discharge device.
